(19) United States
(12) Patent Application Publication
(10) Pub. No.: US 2016/0169180 A1
(43) Pub. Date: Jun. 16, 2016

(54) INTEGRATED FUEL INJECTOR IGNITOR HAVING A PRELOADED PIEZOELECTRIC ACTUATOR

(71) Applicant: McAlister Technologies, LLC, Phoenix, AZ (US)

(72) Inventor: Roy Edward McAlister, Phoenix, AZ (US)

(21) Appl. No.: 14/794,775

(22) Filed: Jul. 8, 2015

Related U.S. Application Data
(60) Provisional application No. 62/022,547, filed on Jul. 9, 2014.
(60) Provisional application No. 62/033,532, filed on Aug. 5, 2014.
(60) Provisional application No. 62/166,369, filed on May 26, 2015.

(51) Int. Cl. F02M 63/00; F02M 51/06

(52) U.S. Cl. CPC F02M 63/0026; F02M 51/0603; F02M 63/0035

(57) ABSTRACT

A fluid injection system and associated systems and methods are described herein. A fluid injection system configured in accordance with an embodiment of the present technology can include, for example, a housing with a fluid inlet port and a fluid outlet port, a fluid metering valve, a valve seat having a valve seat component, and a valve actuator to axially move the metering valve from a seat in the valve seat component from a closed to an open position. The valve actuator can include a piezoelectric assembly operable to displace the valve. The piezoelectric assembly can be exposed to fluid delivered through the fluid inlet port. The materials of the fluid injection system can be made with different materials having substantially similar coefficients of thermal expansion. The materials can have coefficients of thermal expansion that are close or nearly zero at for example, 450 degrees C. and/or −50 degrees C.

### CROSS-REFERENCE TO RELATED APPLICATION(S)

The present application claims priority to and the benefit of U.S. Provisional Application No. 62/022,547, filed Jul. 9, 2014 and titled FLUID INJECTION SYSTEM, U.S. Provisional Application No. 62/033,532, filed Aug. 5, 2014 and titled FUEL INJECTION SYSTEM, and U.S. Provisional Application No. 62/166,369, filed May 26, 2015 and titled INTEGRATED FUEL INJECTOR IGNITOR HAVING A PRELOADED PIEZOELECTRIC ACTUATOR, all of which are incorporated herein by reference in their entireties.

### TECHNICAL FIELD

The present technology relates generally to fluid injection systems, and more specifically to, fluid injection systems for engines having piezoelectric valve actuators and associated systems and methods.

### BACKGROUND

The Intergovernmental Panel on Climate Change (IPCC) recently concluded that global emissions of greenhouse gases have risen to unprecedented levels. Emissions grew more quickly between 2000 and 2010 than in each of the three previous decades. This occurred in spite of a growing number of national and international policies and agreements to reduce climate change.

Anthropogenic GHG emissions grew at an average annual rate of 2.2% over 2000-2010, compared with the previous growth rate of 1.3% per year over the period of 1970-2000. CO₂ emissions from combustion of fossil fuels and industrial processes contributed 65% of global GHG emissions in 2010. The global population of more than a billion internal combustion piston engines is growing at the rate of about 60 million new engines each year and is expected to surpass two billion engines as populous countries continue to increase on- and off-road motor vehicle applications.

Virtually anything that ordinarily rots or burns can be anaerobically dissociated or otherwise processed into carbon and hydrogen. The carbon can be used to reinforce or otherwise improve the capacity of equipment for collecting clean solar, wind, moving water, or geothermal energy in a daily or monthly amount that exceeds the heat released by one-time burning such carbon. Co-produced hydrogen can be utilized in existing engines to produce more power when needed, last longer with less maintenance and actually clean the air that passes through such engines.

However, liquid or fluid fuel injectors can be inadequate for injecting methane or hydrogen directly into the combustion chambers of engines because such gaseous fuels have much lower density. Illustratively, hydrogen has about 3,000 times lower energy density than diesel fuel. Furthermore, gasoline and diesel fuel injectors can fail due to the low lubricity of dry gasses such as methane and/or hydrogen.

### BRIEF DESCRIPTION OF THE DRAWINGS

FIG. 1A is a side view of a portion of heat exchanger for heating and/or cooling fuel delivered to a fuel injector configured in accordance with an embodiment of the present technology.

FIG. 1B is a cross-sectional view of a portion of a fluid injection system in accordance with an embodiment of the present technology.

FIG. 1C is an expanded view take from FIG. 1B of a portion of the fluid injection system.

FIG. 1C-A to C-D illustrate different configurations of wire bars in accordance with embodiments of the present technology.

FIGS. 1D-1F illustrate components and systems according to embodiments of the present technology.

FIGS. 1G-1I illustrate components and systems according to embodiments of the present technology.

FIGS. 1J-1M illustrate components and systems according to embodiments of the present technology.

FIGS. 1N-1S illustrate components and systems according to embodiments of the present technology.

FIGS. 1T-1V illustrate components and systems according to embodiments of the present technology.

FIG. 1W illustrates components and systems according to embodiments of the present technology.

FIG. 1X illustrates components and systems according to embodiments of the present technology.

FIG. 1Y illustrates components and systems according to embodiments of the present technology.

FIGS. 2A-2B illustrate components and systems according to embodiments of the present technology.

FIG. 2C illustrates components and systems according to embodiments of the present technology.

FIGS. 2D-2F illustrate components and systems according to embodiments of the present technology.

FIGS. 2G-1 to 2G-2 illustrate components and systems according to embodiments of the present technology.

FIG. 2H illustrates components and systems according to embodiments of the present technology.

FIG. 2I illustrates components and systems according to embodiments of the present technology.

FIG. 2J illustrates components and systems according to embodiments of the present technology.

FIGS. 3A-3B illustrate components and systems according to embodiments of the present technology.

### DETAILED DESCRIPTION

Devices have been demonstrated to replace presently utilized gasoline and diesel fuel injectors to enable hydrogen and/or hydrogen characterized fuels to overcome greenhouse gas emissions, such as carbonaceous particulates, carbon dioxide and unburned hydrocarbons caused by burning fossil hydrocarbons in existing engines. These devices can combine fuel injection and ignition capabilities, but issue have been encountered concerning piezoelectric valve drivers that provide rapidly adjusted fuel metering in such devices.

Piezoelectric valve drivers have many attractive characteristics, including rapid response time of about 1×10⁻⁶ seconds and relatively high production of force per applied unit of electrical work. Issues of piezoelectric drivers, can include very low productive thrust limits, such as 0.05 mm (0.002″) per 40 mm stack assembly, which requires two or more high aspect ratio columnar stacks to be assembled in a way that prevents buckling of the assembled column and to develop sufficient net driver displacement to enable gaseous fuels to be metered.

Additional problems can concern the exaggeration or cancellation of effective driver thrust by differential thermal expansion or contraction of supporting system components that facilitate piezoelectric driver applications. This defeats the fuel metering system fidelity. Other problems can stem from temperature dependent characteristics, including reduced thrust at cold operating temperatures typical to winter conditions, and damage from operation at higher temperatures that may be typically encountered by fuel injectors exposed to the combustion chamber.

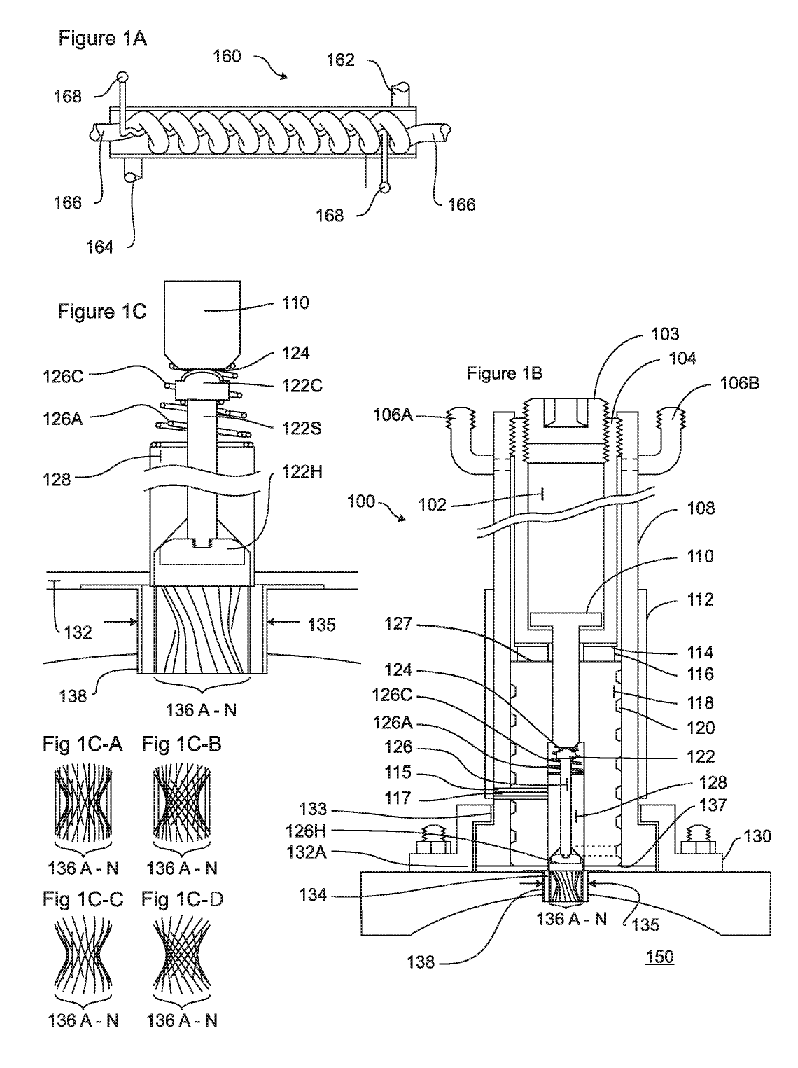

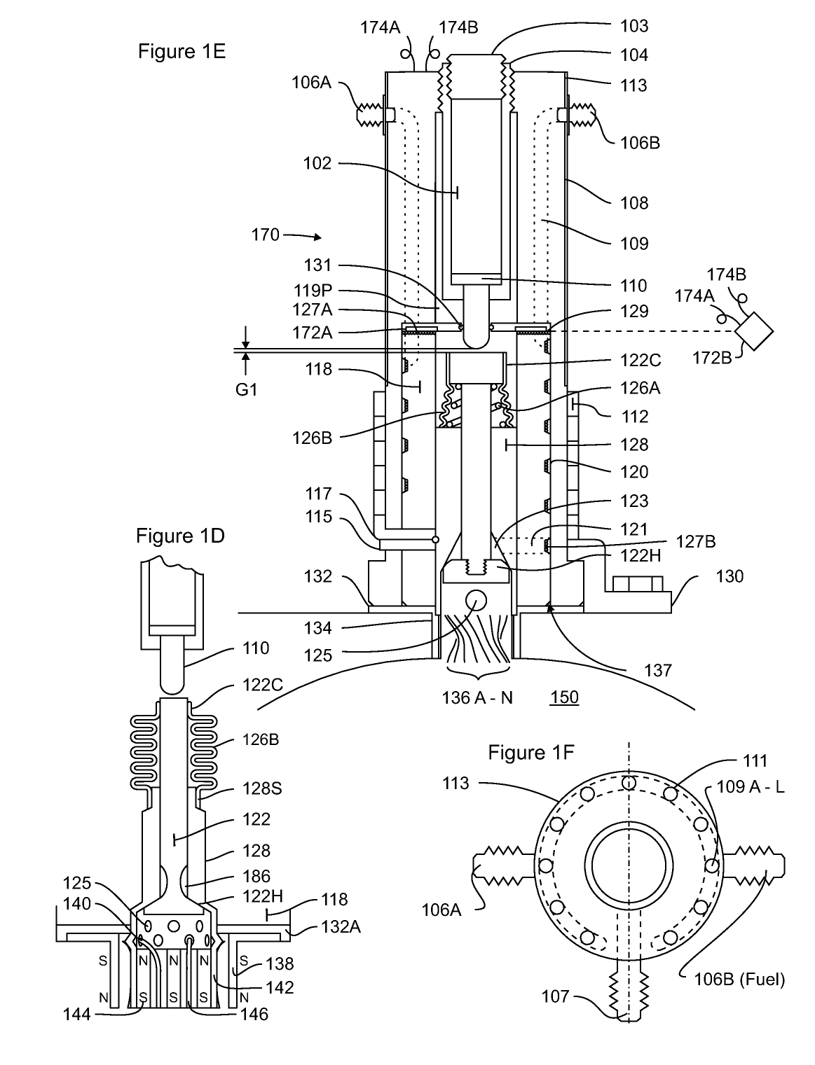

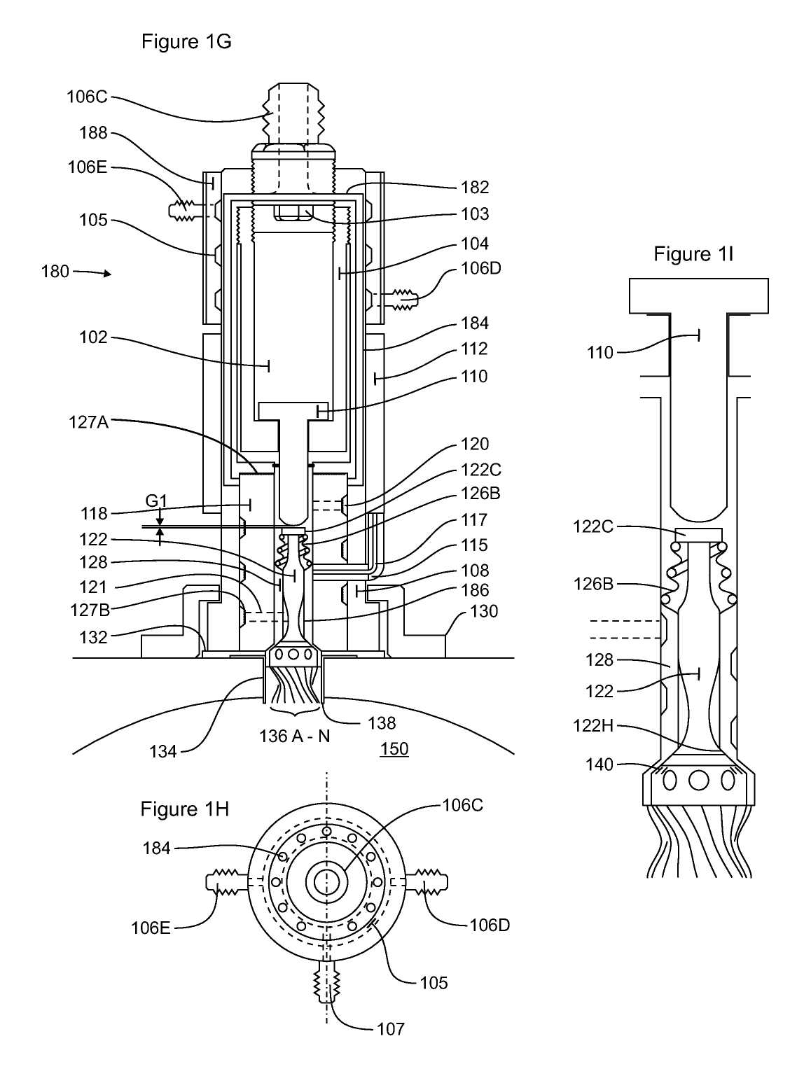

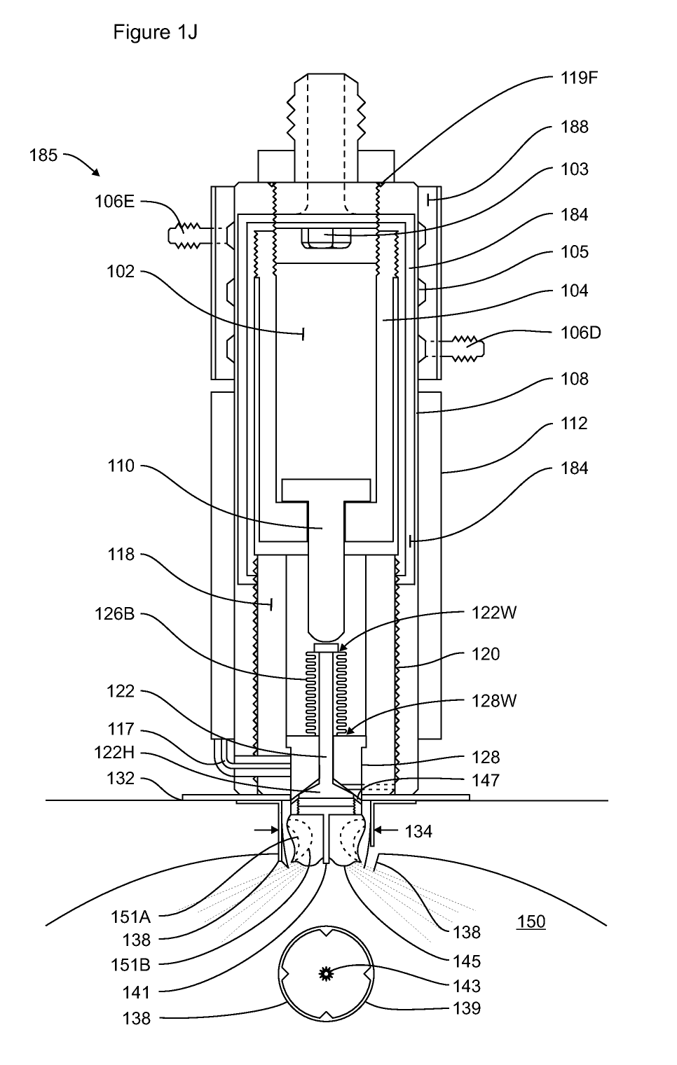

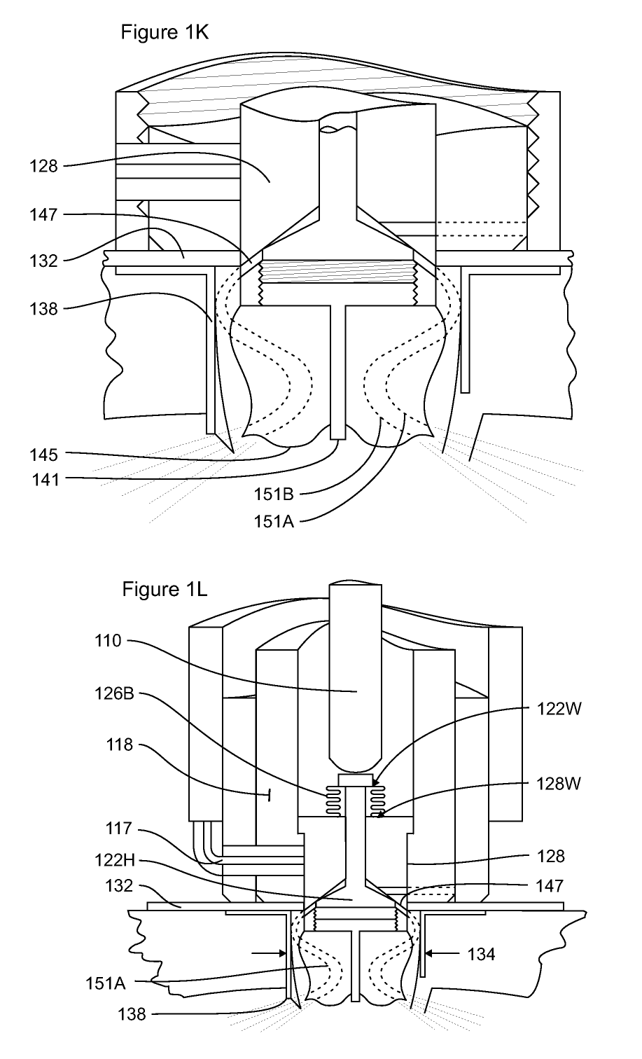

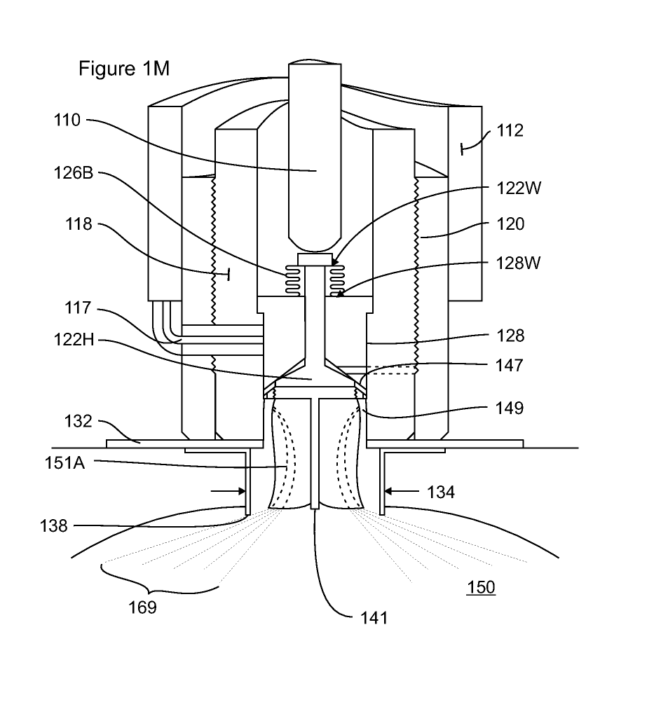

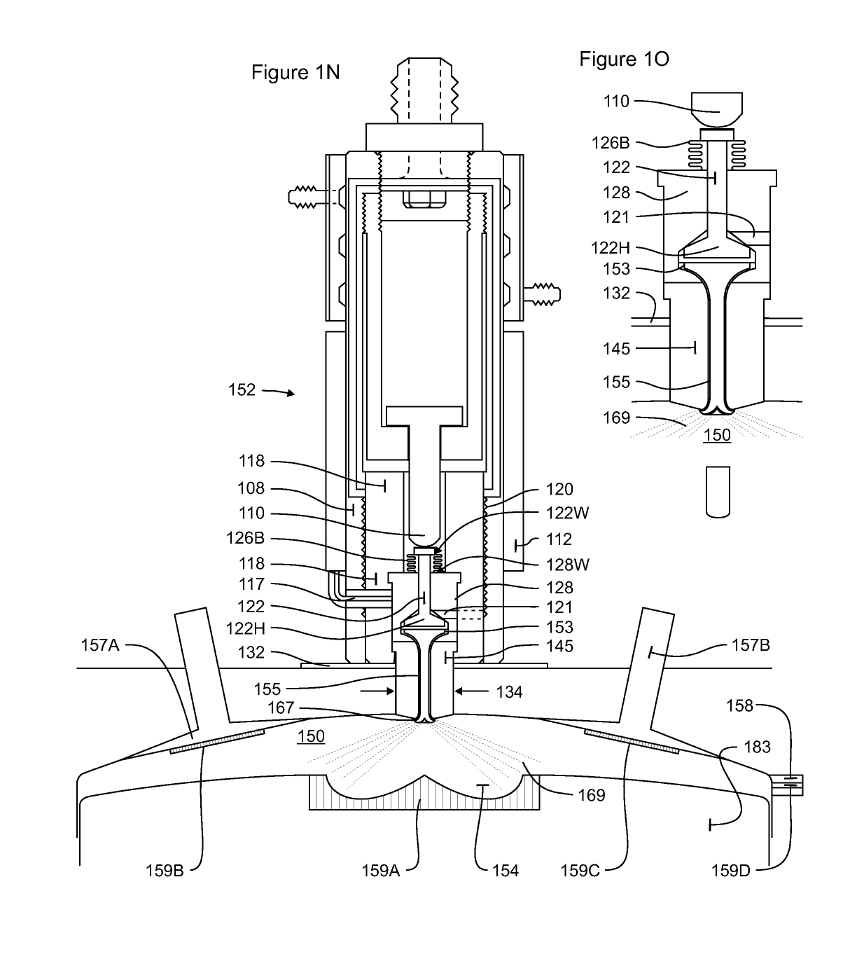

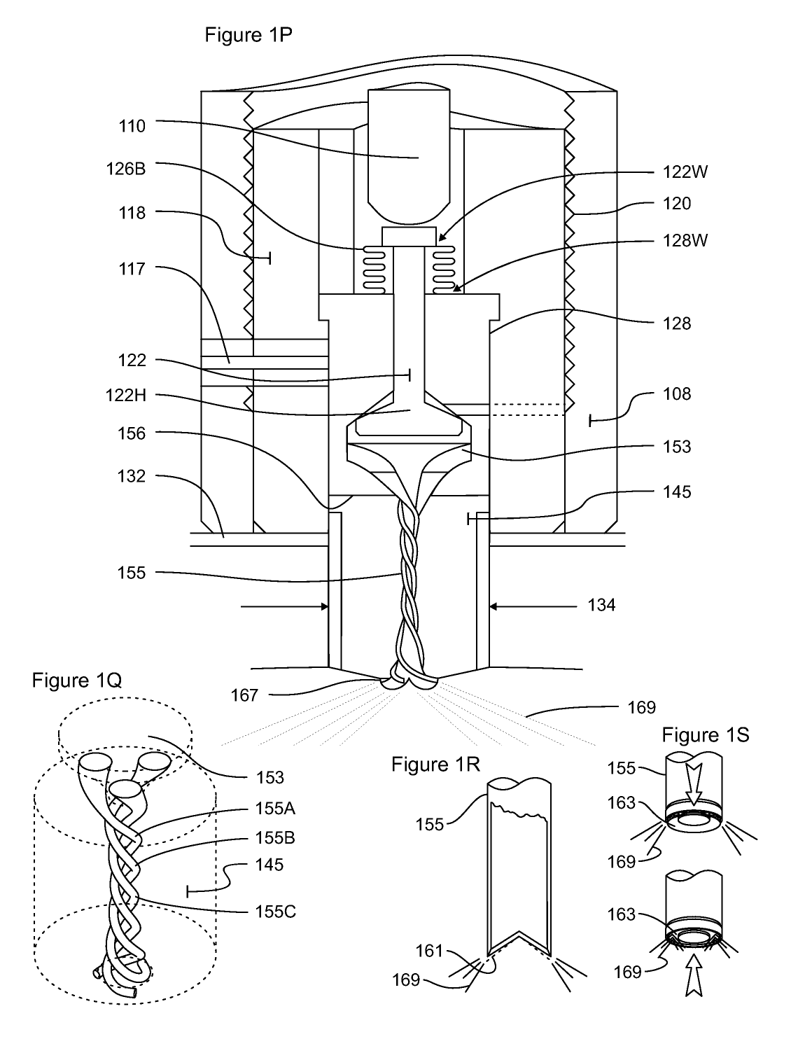

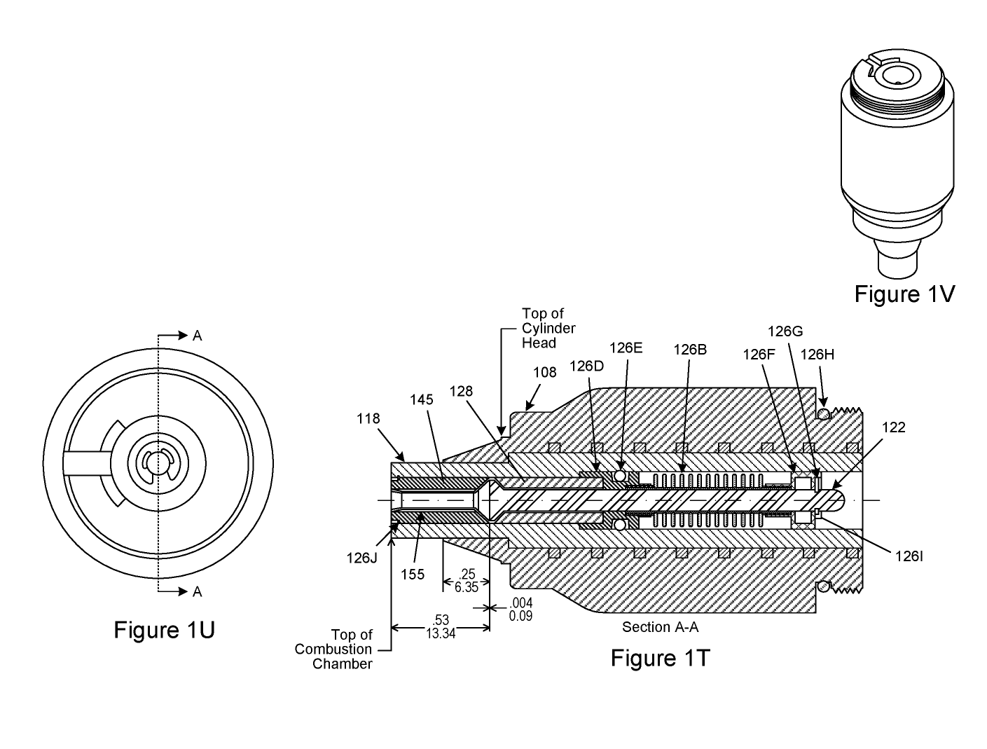

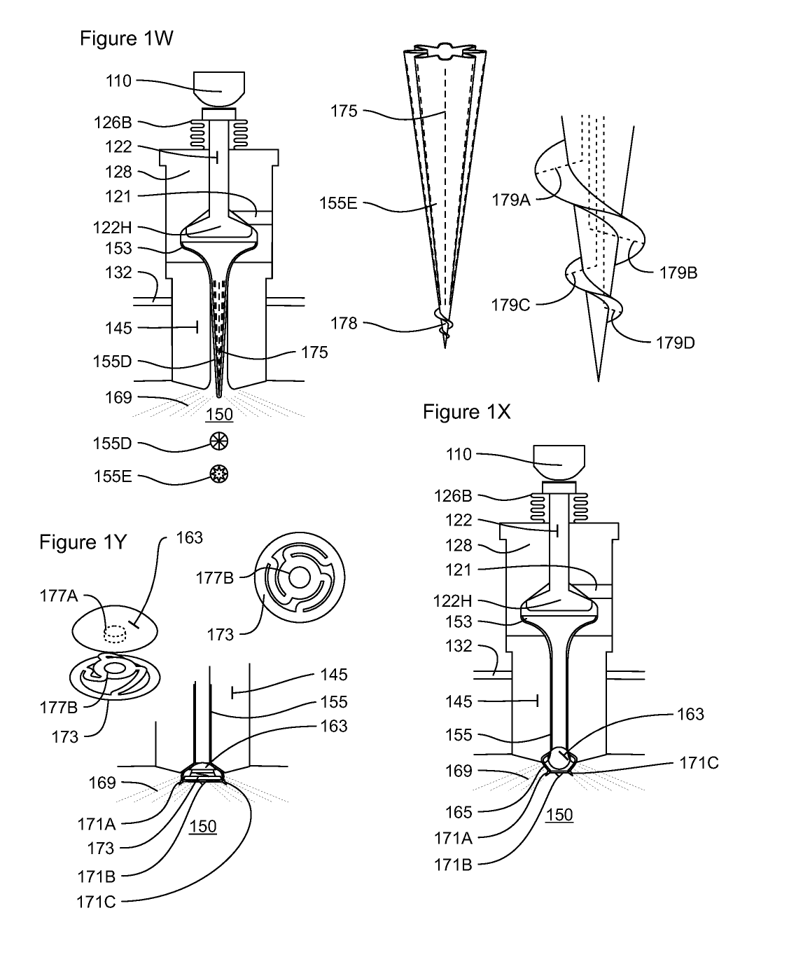

FIGS. 1-3B show components and systems that can solve the difficult problems associated with or improve piezoelectric drivers (e.g., valve actuators), including the very small output displacement that varies significantly with operating temperature. Operating temperatures vary from cold starts in winter weather that may dip below −46° C. (−50° F.) to components that are exposed to the combustion chamber and reach temperatures of 300° C. (570° F.) or more (e.g., 450° C.). In many instances, the dimensional changes in the assembly of components due to thermal expansion and/or contraction rivals or exceeds the piezoelectric actuation displacement. In many configurations, this problem is exaggerated by different thermal conduction and/or specific heat values in components that produce relative motion before reaching equilibrium temperature.

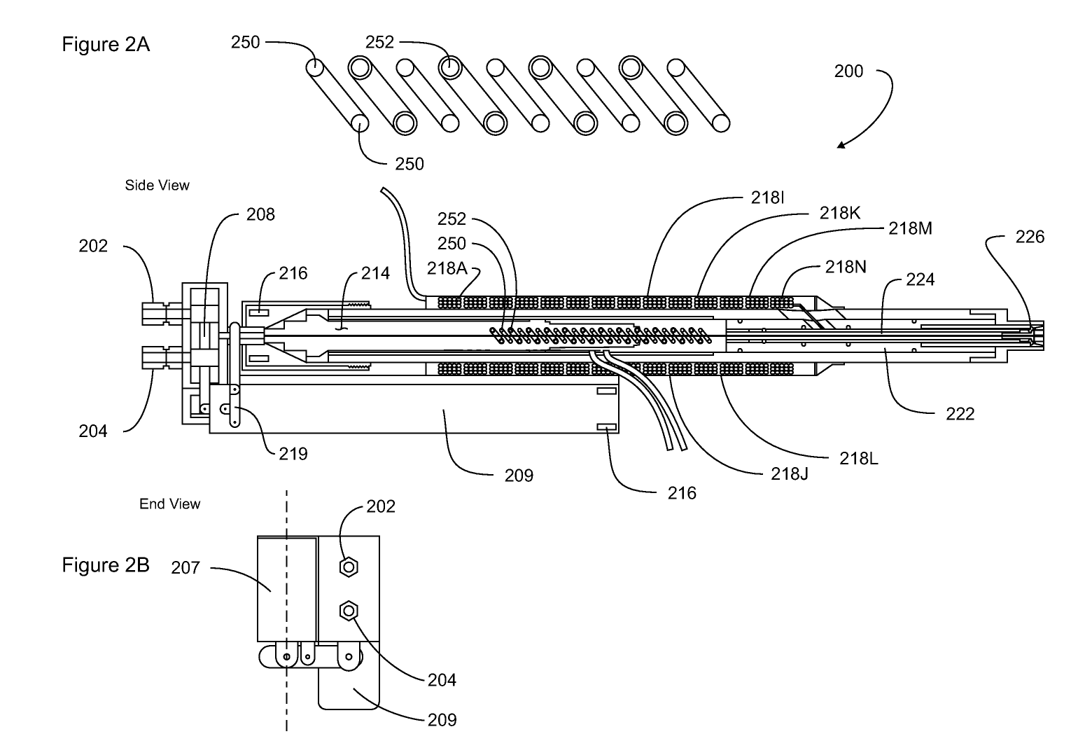

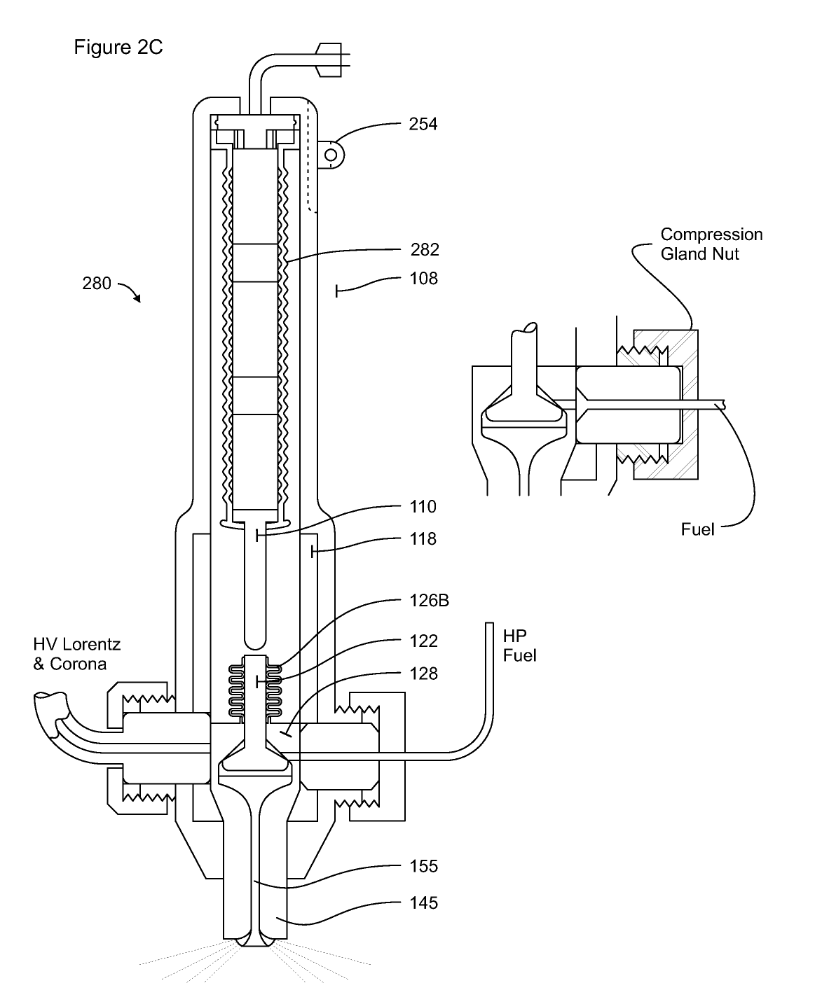

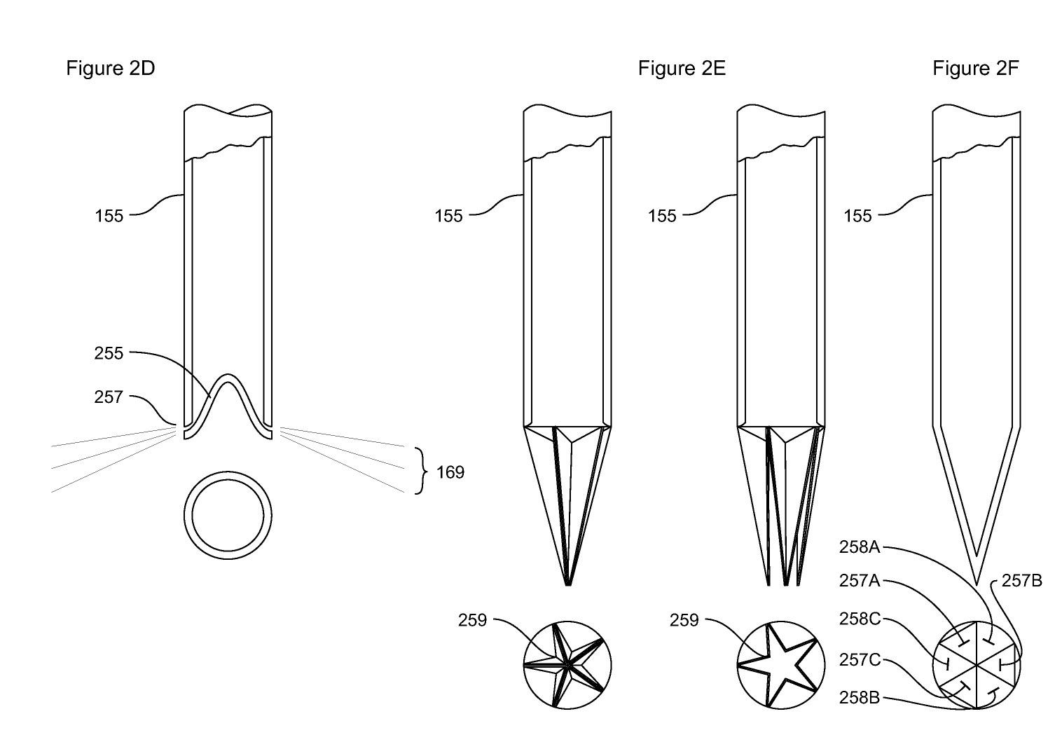

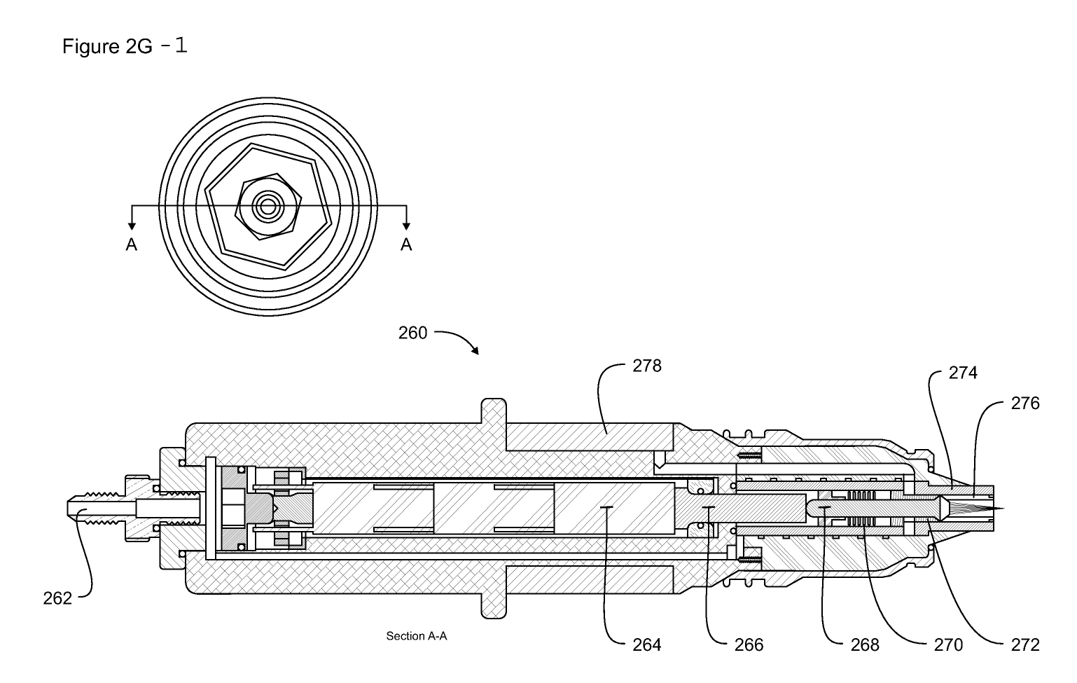

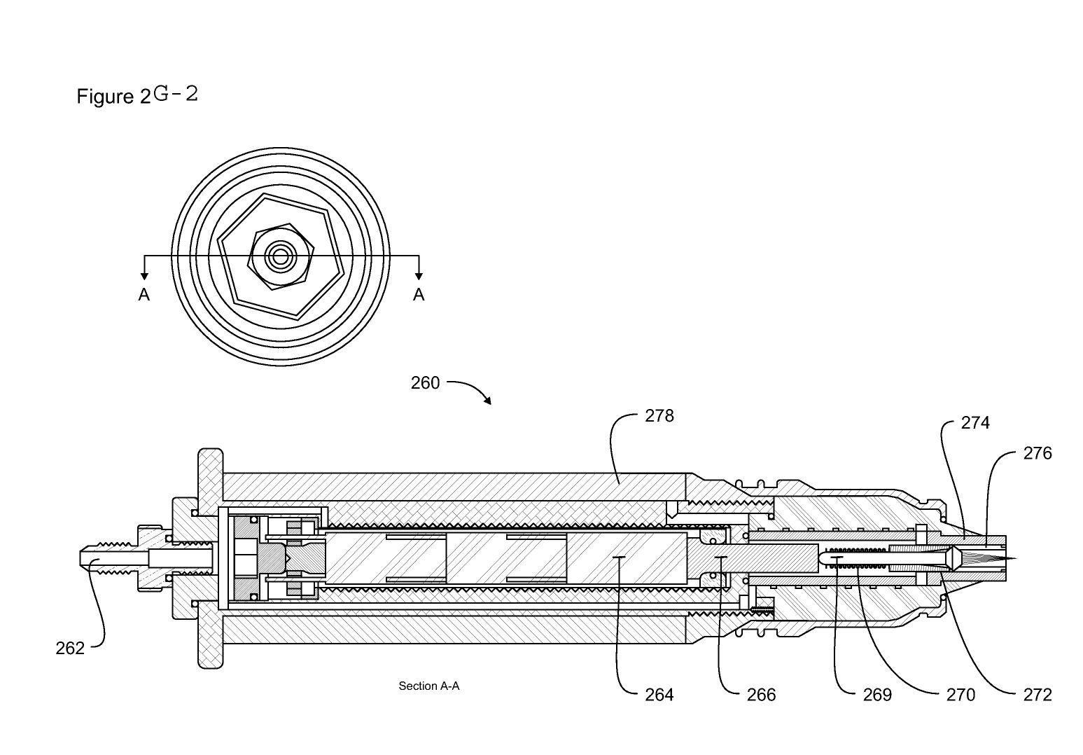

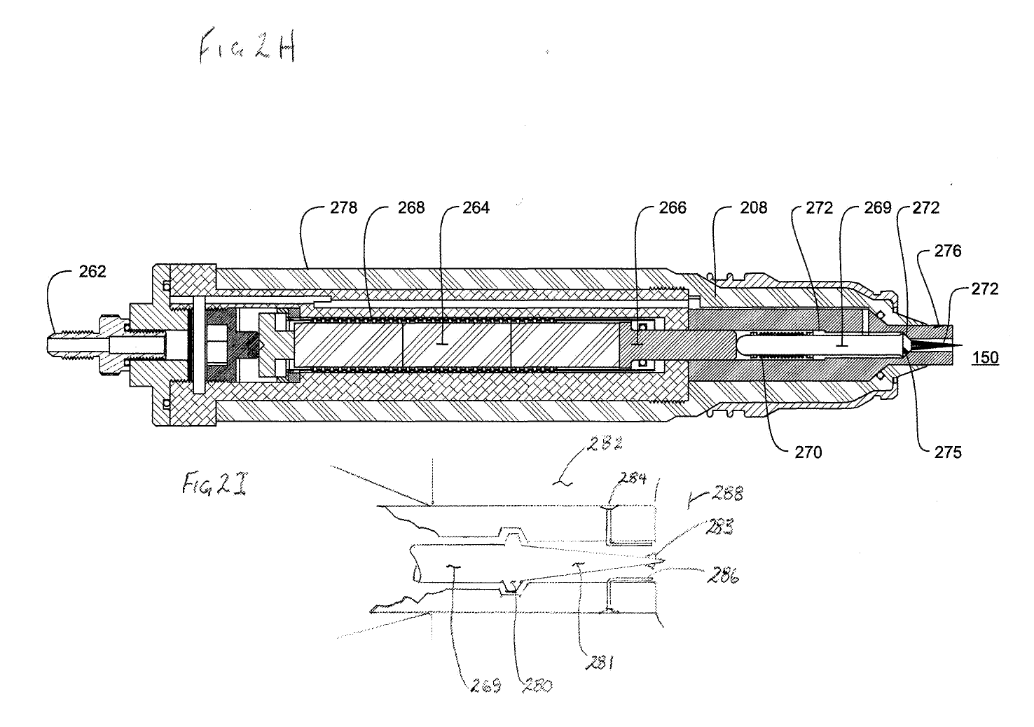

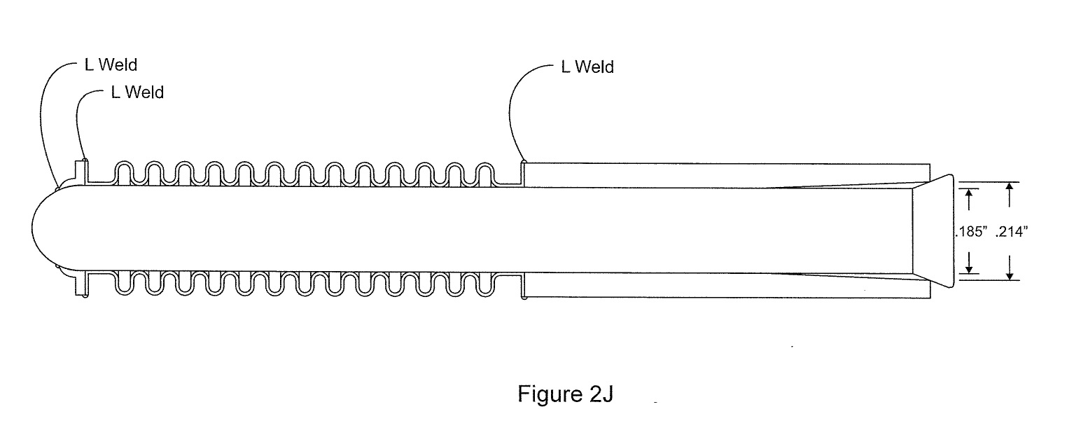

Selected components of embodiment 100, 170 or 180 may be incorporated in place of component assembly 214 in embodiment 200, as shown in FIGS. 2A and 2B. Alternatively, embodiment 100 or 170 can be configured with one or more fluid inlets and/or voltage transformer functions as stand-alone fuel injectors and/or ignition systems.

Illustratively as a stand-alone system, embodiment 100 can overcome these problems by biasing (e.g., positioning) the piezoelectric stack 102 within surrounding fuel flow to maintain an operating temperature that is close to the fuel supply temperature that is delivered from one or more fittings, such as 106A and/or 106B and subsequently, through the annular space between spring canister 104 and housing case 108, both of which can be made of alloys, such as Invar 36 or Invar 32-5, which have very low coefficient of thermal expansion (CTE) values. Table 1 compares properties of several materials for this purpose.

TABLE 1
Selected Hydrogen Compatible Alloy Properties

| ELEMENT | Invar M 63 | Nitronic 50 | Haynes 230 | Inconel 725 | NASA** | MP35N*** | CARBON-FIBER |
|---|---|---|---|---|---|---|---|
| Nickel | 35.5-36.5 | 11.5-13.5 | 57 | 55-59 | (30) Bal | 35 | |
| Iron | Bal | Bal | 3.0* | Bal | 24-34 | N.A. | |
| Chromium | N.A. | 20.5-23.5 | 22 | 19-22.5 | 17-19 | 20 | |
| Tungsten | N.A. | | 14 | N.A. | 3.0-6.0 | N.A. | |
| Molybdenum | N.A. | 1.5-3.0 | 2.0 | 7-9.5 | 3.0-5.0 | 10 | |
| Cobalt | N.A. | | 5.0* | N.A. | 3.0-5.0 | 35 | |
| Vanadium | N.A. | 0.10-0.30 | N.A. | N.A. | 0.1-1.0 | N.A. | |
| Titanium | N.A. | | N.A. | 1.0-1.7 | 2.0-3.5 | N.A. | |
| Niobium | N.A. | 0.10-0.30 | N.A. | 2.75-4.0 | 0.5-2.0 | N.A. | |
| Aluminum | N.A. | | 0.3 | 0.35* | 0.1-0.5 | N.A. | |
| Manganese | 0.50* | 4.0-6.0 | 0.5 | 0.35* | N.A. | N.A. | |
| Silicon | 0.35* | 0.60* | 0.4 | 0.01* | N.A. | N.A. | |
| Carbon | 0.10* | 0.03 | 0.1 | 0.03* | N.A. | N.A. | 90-100 |
| Lanthanum | N.A. | | 0.02 | N.A. | N.A. | N.A. | |
| Boron | N.A. | | 0.015* | N.A. | N.A. | N.A. | |
| Nitrogen | N.A. | 0.20-0.40 | | | | | |
| CTE | 0.6-1.2 | | 14.2 | 7.2-8.1 | — | 15 | −1 to 2 |
| Y.S. KSI | 93 CWHT | 140 CWHT | 120 CWHT | 133 Aged | 175** | 135-290 | 150-300 Composite |

CWHT Cold Worked Heat Treated
*Max;
**NASA_{MFS-31781-1}
***Carpenter MP35N

Spring well 104 can be provided in any suitable shape or form, including barrel, one or more bellows, cylindrical, coniform, etc., as a fiber reinforced composite, such as a glass or carbon fiber reinforced canister, and/or a cladding assembly comprising two or more materials. An exemplary embodiment can comprise a canister material with a relatively high modulus of elasticity, such as an alloy of iridium or a refractory metal, such as TZM or another molybdenum alloy that can be clad to a liner of another layer of material, such as Invar M63, Nitronic 50, Haynes 230, or MP35. This can also provide for protection of the refractory metal alloy by an impervious layer of the corrosion resistant and/or hydrogen compatible alloy. In some applications, a hydrogen compatible layer is clad to the inside and to the outside of a higher modulus material selection to provide an improved combination of fatigue endurance strength, modulus of elasticity, net CTE, and protection against corrosion, such as rusting, stress corrosion degradation, or hydrogen embrittlement. The relative thickness of each layer allows suitable pairing of the composite clad spring well CTE with the CTE of piezoelectric stack 102 to provide improved actuation fidelity through a wider range of operating temperatures.

In certain applications an electroplated or hydroformed bellows such as a ferrous or non-ferrous or superalloy selection, is utilized as a preform that is plated with additional substances, such as diamond-like-coating (DLC), graphite, carbon or carbide nanotubes, carbon or carbide filaments, ceramic, nickel, cobalt, and/or selections from the platinum or refractory metal groups for purposes such as adjustment of the net coefficient of thermal expansion, adjustment such as increasing the spring rate, corrosion and/or hydrogen embrittlement resistance. Illustratively, the preform can serve numerous different applications by such plating operations to provide adjusted CTE and/or spring rates and/or resistance to various degradation factors. Table 2 provides comparisons of selected elements that can be used for imparting properties, such as corrosion resistance and/or adjusted spring rates.

TABLE 2
Young's Modulus = E/(GPa)

| Atomic | | | |
|---|---|---|---|
| number | Symbol | Name | Modulus |
| 4 | Be | beryllium | 287 |
| 11 | Na | sodium | 10 |
| 12 | Mg | magnesium | 45 |
| 13 | Al | aluminium | 70 |
| 14 | Si | silicon | 47 |
| 22 | Ti | titanium | 116 |
| 23 | V | vanadium | 128 |
| 24 | Cr | chromium | 279 |
| 25 | Mn | manganese | 198 |
| 26 | Fe | iron | 211 |
| 27 | Co | cobalt | 209 |
| 28 | Ni | nickel | 200 |
| 29 | Cu | copper | 130 |
| 30 | Zn | zinc | 108 |
| 40 | Zr | zirconium | 68 |
| 41 | Nb | niobium | 105 |
| 42 | Mo | molybdenum | 329 |
| 44 | Ru | ruthenium | 447 |
| 45 | Rh | rhodium | 275 |
| 46 | Pd | palladium | 121 |
| 47 | Ag | silver | 83 |
| 48 | Cd | cadmium | 50 |
| 49 | In | indium | 11 |
| 73 | Ta | tantalum | 186 |
| 74 | W | tungsten | 411 |
| 75 | Re | rhenium | 463 |
| 77 | Ir | iridium | 528 |
| 78 | Pt | platinum | 168 |

As noted in Table 2, several composited elements can be utilized to provide desired combinations of properties. Illustratively, a layer of an alloy or nickel with a relatively low modulus of elasticity can be hydroformed or electroformed in a suitable bellows design that is subsequently utilized as a preform for deposition of one or more additional layers, such as iridium, tungsten, or molybdenum to provide a much higher modulus of elasticity. Such material selections for composited bellows can provide a higher net spring rate to meet the requirements of various applications, along with corrosion resistance and infinite fatigue endurance performance.

In certain instances, the cylindrical neck on one or both ends of bellows 270 is welded or adhesively bonded, and the neck region is reinforced by over-winding high strength filaments with a suitable adhesive, such as epoxy, polyimide or thermosetting polyester to form a composite assembly. Suitable filaments include polymer, such as Kevlar, glass, ceramic, various carbide and carbon fibers.

Another high strength composite embodiment for applications such as spring well 104 and/or bellows 126B, utilizes a liner of Invar 32-5, or Invar M63 that is coated with diamond like carbon and/or reinforced with high strength carbon filament to provide a very low CTE and high fatigue endurance strength. Such low CTE liner materials can be selected for impervious containment of gases such as hydrogen and to provide a suitable form for winding reinforcement filaments such as carbon, polyimide, or glass. In various instances, the case 108, spring well canister 104, and other components may have a relatively low modulus of elasticity material, such as an Invar alloy that is reinforced by a high strength and modulus of elasticity fiber, yarn or cloth that can be wound, woven, wrapped, or layered in any suitable combination of matrix resin, winding tension, and strand angles, patterns or form factors. Glass, Kevlar, and/or carbon fiber reinforcement provides high fatigue endurance strength and very low CTE to enable the composited spring well to be engineered for net CTE, elastic modulus, corrosion protection and other optimized performances. Carbon fiber may be mixed with other fibers and a variety of matrix materials, such as nanotube reinforced epoxy, polyimide or thermoset polymers to customize the composited assembly.

Further electrical and thermal isolation, along with rigidity, is provided by plunger 110 by a low CTE ceramic composed of SiO₂—Al₂O₃—Li₂O glass-ceramic, or quartz that includes a component with a positive coefficient of thermal expansion and a component with a negative coefficient of thermal expansion. Such low CTE materials can also be utilized for dielectric and thermal insulators 110 and 118, including the assembly of embodiment 170. Thermal isolation is continued by elastomer gasket seal 114, which may be a suitable composition, such as silicone rubber or foam, that serves as an accommodation spring to allow displacement by the spring canister assembly 104 with piezoelectric stack 102 and protection of adaptive solid state controller 116, which processes combustion chamber information, including pressure, temperature and combustion patterns that are optically signaled through transparent ceramic 118 and/or from sensors at the interface to combustion chamber 150, including sensors that may be located in combustion chamber inserts in locations, such as the head gasket, piston, intake or exhaust valves and/or at other locations.

Low CTE ceramic 118 can also be biased to the temperature of fuel flow through one or more suitable passageways, such as channels or helical grooves 120, and one or more passageways to an annulus above valve 122 against the valve seat seal in electrode 128. Electrode 128 can be made of low CTE alloy selections, such as Invar 36 or Invar 32-5, to further limit relative motion due to CTE differences. Enclosure spring 126B may be of any suitable shape and material selection, such as barrel, one or more bellows, cylindrical, coniform, etc. Enclosure spring 126B can be bonded, such as by adhesives, laser or electron beam welding, or brazing to cap 122C on the stem of poppet valve 122 and to electrode 128 to provide a sealed assembly for controlling fluid flow from inlets, such as fittings 106A, 106B and/or 106C to combustion chamber 150.

Extended fatigue endurance life of compression springs 126A and 126C, as shown in FIGS. 1B and 1C, can be provided by valve spring alloys. Spring bellows 126B, as shown in FIGS. 1E and 1G, may be used in conjunction with spring 126A and/or can be provided as a durable corrosion and hydrogen embrittlement resistant composite or multiple layer assembly. Illustratively, the inner layer that is exposed to fuels that may occasionally comprise hydrogen can be made of a hydrogen compatible alloy selections, such as Inconel 725 or MP35N, and one or more subsequent layers can be made of 4130 martensitic alloy, type 420 and/or other stainless steels to provide the synergistic combination of chemical stability, along with sufficiently high fatigue endurance strength.

Another embodiment provides a hydroformed or electroformed composite of sulfur free copper and/or nickel inner layer, a higher modulus middle layer (i.e. diamond like carbon or DLC, graphene, platinum, iridium, tungsten, tantalum, molybdenum, etc.) sandwiched between an outer layer of corrosion and hydrogen embrittlement resistant nickel or Inconel 725. This enables design choices of material selections and thicknesses to provide customized properties, such as modulus of elasticity, CTE, and resistance to corrosion or hydrogen embrittlement to meet an extended range of application requirements.

Further thermal isolation of the embodiment assembly 100 can be provided by insulating component 132, which can be a suitable material or composite of materials such as mica, ceramic, or fiber mesh and a resin such as polyimide. Insulating component 132 can have windows or mica windows to allow radiative spectra to be transmitted to controller 116 through transparent ceramic 118. In some instances, component 132 centers electrode 128 within the bore typically provided for an injector, such as a diesel injector, that is replaced by embodiment 100. In certain instances, insulating component 132 also includes a liner 134 that fits within the injector port and serves as a counter electrode to electrodes, such as wire bars 136 A-N extending from electrode 128, some of which can be formed as loops and/or hyperbolic parabolic elements that prevent valve 122 from over excursion into combustion chamber 150 in case of a failure of compression spring 126A or 126B. Features, such as one or more projections 135, provide centering and suitable spacing of electrode 128 and/or wirebars, such as 136 A-N, from liner 134 or the bore of the injector port.

Valve 122 can be any suitable type and can be made of low CTE alloy, such as Invar 36, Invar 32-5, or other suitable selections, including single crystal alloys. Wire bars 136 A-N that extend from electrode body 128 may be made of Haynes 230, Inconel 750, silicon carbide, molybdenum disilicide, tungsten or selected refractory alloys for extended endurance in Lorentz ion launching service. Voltage transformer 112 may be of any suitable design, including successive pulse coils that transform low primary voltage to suitable high voltage to start a small current that is quickly increased upon reduction of impedance by the initiating ion current to produce suitable populations of ions that are launched into combustion chamber 150. High dielectric strength tube 115 can be utilized to contain the high voltage electrical energy from transformer 112 through case 108 to electrode 128.

In instances that a very low temperature start up is desired, the piezoelectric stack 102 may be dry cycled to generate a suitable operating temperature and/or it may be warmed by preheating the fuel, such as hydrogen, methane, propane, ammonia, etc., that is delivered through fitting 106A and/or 106B. Similarly at times that it is desirable to limit the operating temperature of stack 102, the fuel delivered through fitting 106A and/or 106B may be precooled by a fluid, such as water and/or by partial evaporation of water in heat exchanger 160.

Illustratively, heat exchanger 160 provides electrical resistance and/or inductive heating of fuel by element 168 proximate to tube 166 at times it is desired to warm piezoelectric stack 102. At times it is desired to cool or maintain the temperature of stack 102 by heat removal, a coolant fluid, such as water with/or without a phase change, is provided through the circuit from fitting 162 to 164 around fuel in tubes 166.

In some embodiments, dispersion strengthening provides very low CTE along with higher yield and fatigue endurance strength. Illustratively dispersions of additives, such as hafnium carbide and/or yttria (Y₂O₃), may be utilized to dispersion strengthen alloys, such as 1-2% Y₂O₃, 36% Ni, balance Fe or similar dispersion strengthening can be provided to Invar 32-5, Nitronic 50, Inconel 725, and other selections. In certain embodiments the alloys, methods and apparatus disclosed in U.S. Pat. Nos. 3,749,612 and/or 5,688,471 which are incorporated by reference, can be utilized for such strengthening.

In some embodiments an upper valve head is utilized for purposes, such as increasing heat transfer rates and/or balancing valve forces, in conjunction with the metering valve head. Illustratively, valve head 122H and/or cap 122C may be formed as one or more cold headed features or selected components, such as valve head 122H may be attached by laser welding or brazing and/or by a threaded portion of valve stem 122S to facilitate assembly with electrode 128. This provides minimal side thrust and low friction centerline guided action of valve 122H to and from the valve seat in electrode 128.

Any suitable attachment of embodiment 100 to the combustion chamber may be provided. Illustratively, embodiment 100 may be threaded to fit a spark plug port, or it may be held in place against a suitable compression seal 132 by one or more clamps, such as 130, which may be of any suitable design for placement at any suitable location, such may have previously been utilized for securing a diesel fuel injector. Insulator 133 may be of any suitable material, such as molded mica, ceramic fiber compact or alumina, to provide insulation of fastener 130 from case 108. In operation of an exemplary embodiment, valve 122H is normally closed against the seal ring seat in electrode 128 and is moved outward to allow fluid flow by application of force exerted by piezoelectric stack 102 through plunger 110 to elastically press spring form 124 against the dome of valve cap 122C and cause deflection of spring bellows 126 to the extent controlled by the adaptively controlled voltage applied to stack 102. Pressurized flow of fluid, such as fuel, is then delivered past electrode wire bars 136 A-N, which can serve as spark, Lorentz ion current launch electrodes in conjunction with the counter electrode of the bore of port 138 or the liner 134, which may be included in certain instances. Wire bars 136 A-N may also serve as electrodes that project an electric field for one or more suitably short periods, such as 10 to 60 nanoseconds, to produce corona discharges in the pattern of fluid penetration, such as oxidant and/or fuel, that is injected into combustion chamber 150.

FIG. 1D shows an embodiment that combines a compression spring bellows 126B that is sealed to valve 122C and at 128S to electrode 128 to urge valve 122 to the normally closed position of valve head 122H against the adjacent valve seat in electrode 128. One or more ports 125 in the skirt of electrode 128 allow photo-optical instrumentation, such as 127A and 127B, to monitor events in combustion chamber 150. In certain embodiments, heat-resistant fiber optics 146 extend from selected ports 125 to suitable locations to monitor combustion chamber events. In some embodiments, electrode liner 138 provides permanent or electromagnets 138S and/or 138N in suitable pole configurations that may or may not interact with selected pole configurations of magnets 144N or 144S in electrode skirt 128 to provide magnetic lens acceleration of oxidant and/or fuel ion currents that are generated between electrodes 142 and 138 to provide desired penetration patterns of Lorentz thrust ion currents.

Oxidant that is cyclically compressed into the annular space between electrodes 138 and 142 can be ionized and Lorentz thrust in penetration patterns into combustion chamber 150. Subsequently upon opening of valve head 122H, fuel flow through one or more grooves 140 or ports 147 to the more or less annular space between electrodes 128, or 142 and 138, can travel at subsonic or sonic velocity according to adaptively controlled fuel pressure and can further be adaptively ionized to produce a Lorentz thrust current at a higher velocity to overtake oxidant ions in the previously established penetration pattern to accelerate initiation and/or completion of striated, stratified, or partially homogeneous combustion of fuel with oxidant such as air, oxygen enriched air, or oxygen. In some embodiments, fuel flow past valve 122 is restricted by a suitable seal to flow through radial ports 140 to the annular space between port 134 and an electrode selection, such as 141. In other instances, fuel flow is proportioned between ports 140 or 147 and the annular space around valve head 122H.

Embodiment 170 of FIG. 1E shows a piezoelectric valve driver 102 that is held in compression within spring well 104 by a suitable method, such as a preload set screw 103 that can be prevented from loosening by a suitable adhesive. Spring well 104 is suspended within case 108. Suitable material selections for spring well 104, case 108, ceramic 118, valve 122, and electrode assembly 128 include Invar 36 and various other alloys with low and/or matching CTE values. Spring well 104 can also be formed as a bellows or other suitable shape and can comprise a glass or carbon fiber reinforced composite or multiple layers of equal or unequal thicknesses of material selections, such as Invar, Inconel 725, MP35N, Martensitic types 4130, stainless 410, 420, 440 and/or 347 or other 18-8 alloys.

Embodiments such as 100, 170 and/or 180 can be assembled from material selections with matched CTE values, including selections with low CTE values, and may utilize construction adhesives, solder or braze alloys, interference or closely fit components, including suitably swaged or otherwise formed and shaped, fit and sealed sub-assemblies and integrated systems. Illustratively, embodiments such as 100, 170 or 180 can be assembled with closely fitting components, including application of a suitable adhesive and case 108 can be swage formed at zone 137 to seal and compressively load ceramic sub-assembly 118 in place, as shown. In some embodiments, a seal is provided by one or more coating(s) on mating components to effectively provide one or more cylindrical coatings or cylindrical wedges or thin walled truncated cono-forms of high temperature substances with sufficient elastomeric properties to conform to the respective mating surfaces, including the edges of grooves, and thus form seal areas that are increased with the compressive loading produced by assembly procedures and/or the force applied by one or more clamps 130 against features of case 108. Suitable materials for forming such compression seals include polyimide (e.g. Kapton), chemical vapor deposited poly(p-xylene) selections, such as Parylene D, and/or PTFE, that may or may not be applied or assembled with pressure sensitive adhesives. In certain instances, one or more sealing substances are applied through a conduit, such as 106C to provide a coating, such as a deposition or chemical conversion layer on surfaces, including the interface between mating components.

Pressurized fluid, such as fuel and/or coolant is connected to ports, such as 106A and/or 106B, and delivered to one or more heat exchange circuits, such as a helical groove within a braze assembled sleeve 113 that extends from fittings 106, to provide flow in helical grooves 120. Another exemplary passageway can be provided by groove 111 that is sealed such as within braze assembled sleeve 113 to one or more passageways, such as 109 to provide fluid, such as fuel, that can be conditioned by heat exchanger 160 to bias the temperature of case 108.

Case 108 thus becomes an effective heat exchanger to heat or cool fluid selections, or selected heat sink materials, such as sodium sulfate, a mixture of sodium sulfate and sodium chloride, various waxes, paraffins or other multiphase substances; hydrogen or helium and/or to provide dielectric insulation combined with heat transfer properties, including sulfur hexafluoride (SF₆) and/or refrigerants, such as R-12, R-116, R-290, R-C318 (octafluorocyclobutane C₄H₈), or R-600a that can be charged through port 107, and thus annular space between spring well 104 and case 108, as shown in FIGS. 1D, E, and F. In some instances, a combination of a solid that is partially converted to another phase, such as a liquid, is utilized in combination with another liquid that becomes a vapor to produce a greater thermal capacitance or “flywheel” to heat dam and/or stabilize the temperature of components comprised with case 108.

Utilization of selected refrigerants can provide the benefit of heat pipe or phase change thermal stabilization. Illustratively, for more or less upright positions of assembly 170, cooled fluid temperature biased case 108 is typically coolest near the top and can produce refrigerant condensate near the top of spring well 104, which flows toward heat conducted from combustion chamber 150. In other instances, a suitable capillary wick (not shown) may be utilized to return condensate to the evaporation zone. This provides advantageous heat transfer as evaporated refrigerant vapor then travels toward the top to repeat the process to provide maintenance of the desired component temperatures, including piezoelectric stack 102 and/or electro-photo-optics 127A on disk 129. In some high frequency applications, refrigerant is allowed to travel to the space around the outside of spring bellows 126 to increase the rate of heat exchange from valve 122 and/or ceramic 118. In other instances, a seal 119V and/or 119P is provided by disk 129 to prevent refrigerant from passing into the space below disk 129. The heat pipe and change of phase flywheel systems can be at the same location or at different locations that can be selected to control the operating temperature of one or more critical components or subsystems.

Fluids, such as fuel or coolant, are delivered through passageways 109 to passageways, such as helical groove 120, to one or more passageways 121 to annulus 123 above the valve seal ring against electrode 128. Spring bellows 126 are sealed to valve cap 122C at one end and to electrode 128 at the other end to provide assured containment of fluid delivered to annulus 123 until valve 122 is forced open by plunger 110 in response to thrust by valve driver 102.

Upon opening of valve 122, according to adaptive control of the magnitude of voltage applied to piezoelectric valve driver stack 102, fluid is directly injected into combustion chamber 150. One or more windows, e.g. 125A-F in the skirt of electrode 128, provide radiant energy transfer to and/or from combustion chamber 150 through transparent ceramic 118 to optical readers and/or electro-photo-optic emission devices attached to or sandwiched against the components of gap (G1), such as adjustment disk 129, or that may be located within or on the bottom or on other surfaces, such as the walls or in selected zones of inside or outside diameter grooves, such as 120.

In an illustrative application of a gas turbine or a piston engine, such as a converted two or four stroke diesel-type, embodiment 170 is placed in the same port that was originally provided for the direct injection diesel injector and is held in place and sealed by centering gasket 132 that can include a port liner electrode 134. One or more clamps 130 provide hold down and sealing of the system assembled within case 108 to the engine. Fuel such as hydrogen, carbon monoxide, and/or methane delivered through ports 106A-B biases the temperature of case 108 and thus, through heat transfer fluid such as helium, the temperature of stack 102 is maintained within a desirable operating range. Pressurized fluid, which may be coolant and/or fuel, is delivered through passageways 109, 120, and 121 to annulus 123.

Controller 172A and/or 172B provides actuation of driver 102 at adaptively controlled crankshaft angles, along with adaptively controlled voltage applied through suitable cables 174A-B, to open valve 122 for providing controllably metered flow of fuel past wire bar electrodes 136 A-N, some of which can be formed to prevent the possibility of over-excursion of valve 122 towards combustion chamber 150, such as shown in the configurations of FIGS. 1C-A, 1C-B, 1C-D. In this regard, wire bars selected for preventing the possibility of over-excursion by valve can be made of high strength super alloys, such as NASA 23, NASA MFS-31781-1, MP35N or Inconel 725. Such alloys are heat and oxidation resistant in addition to being hydrogen compatible, and can further serve as incandescent ignition initiators and/or accelerators of fuel combustion in homogeneous and/or stratified charge combustion events.

Alternatively, ignition and/or acceleration of combustion may also be provided by including one or more chemical plasma inducing agents, such as dimethylether (DME), diethyl ether (DEE) or other compounds, along with fuel selections, such as methane, hydrogen or carbon monoxide. This enables operation with or without electrically induced ignition, such as spark, Lorentz thrust ions or corona plasma production. It is particularly beneficial to produce such chemical plasma production agents from easily stored liquid fuels, such as methanol or ethanol as summarized by Equations 1 and 2, which may include removal or reduction of water that is formed for the purpose of operating an engine without electrically induced ignition. Such operation without electrically induced ignition may include normal operation in certain embodiments and/or emergency operation in other embodiments.

2CH₃OH→CH₃OCH₃+H₂O Equation 1

2C₂H₅OH→C₂H₅OC₂H₅+H₂O Equation 2

In other instances, chemical agents can be utilized with hot wire bars 136 or other suitable electrode zones or configurations to initiate or accelerate combustion, including normal operation in certain embodiments and/or emergency operation in other embodiments. Accordingly, engine operation can be provided by any suitable permutation of homogeneous or stratified charge combustion that may be initiated or accelerated by spark, Lorentz ion thrust, corona, hot zone, i.e. spot, wire, or filament, and/or by one or more chemical plasma agents, including one or multiple bursts that are introduced into the combustion chamber.

Operation with electrically induced ignition and/or acceleration of combustion events can utilize any suitable voltage transformer, including the type depicted as a composited assembly of transformer 112 on case 108 or on or within heat exchanger 188. Suitably high voltage, such as 20KV to 60KV produced by a suitable transformer, such as 112, can be delivered by conductor 117 within high dielectric strength and suitably shielded tube 115 to electrode 128. Ceramic 118 and/or electrode 128 and/or case 108 can include assembled portions that serve as one or more capacitors in electrical circuits with transformer 112 to produce spark, Lorentz thrust ions and/or corona plasma ignition and/or acceleration of combustion events.

Embodiment 152 of FIG. 1N illustrates another embodiment in which pressurized fuel can be delivered through heat-exchange passageway 120 and one or more passage ways 121 through insulator 118 to normalize the temperature of the assembly of case 108 components, such as insulator 118, voltage source 112, electrode 128 and valve 122H. Ceramic 145 and heat dam 132 provide thermal and/or electrical insulation to reduce the heat gain rate of the assembly from heat generated in combustion chamber 150. In some instances, additional heat removal and transfer is provided by operation with a phase change substance around compression spring bellows 126B using suitable phase change material selections, such as paraffin or refrigerant.

The substance space 145 can be occupied or partially occupied with a suitable dielectric fluid or a pressurized gas, such as methane, ethane, propane, or refrigerant or with a ceramic, glass or a composite that is opaque with light pipe or fiber optic viewing filaments sufficiently transparent to enable optical instrumentation sensors 156 to monitor combustion chamber 150 to determine combustion chamber conditions, such as the temperature and/or pressure, along with occurrences, such as plasma production and combustion events and patterns from a suitable location, such as at interface 156. Illustratively in instances that substance space 145 is occupied by a high dielectric solid ceramic, such as alumina, magnesia, silica, or a glass ceramic, it can be shaped to provide for one or more electrode(s) 155 to be recessed within one or more conical or cylindrical recess, or extended to the surface, or somewhat protruded past the surface of 145, as shown, for the purpose of shaping and presenting sufficient field strength to initiate corona plasma in the space between proximate portions of electrode(s) 155 and piston 183, and/or an inlet or exhaust valve 157A or 157B, and/or an antenna 159D presented within head gasket 158, or inserts such as 159A, 159B, or 159C that may have the same or different extents and shapes compared to the supporting component, as shown.

In some instances a conductive plating or surface coating, such as nickel, copper, gold, or platinum, etc., is utilized for at least part of antenna 155, or it may be comprised of an electrode tube 155 and ceramic body 145 that are made of materials with nearly matching thermal expansion characteristics, such as Invar and quartz, or Zerodur, to provide thermal shock resistance and durability. One or more fuel passages and antenna of any suitable configuration may be used including the three helical passageways 155A, 155B, and 155C as shown in FIG. 1Q. Such passageways may be open to accept compressed oxidant from the combustion chamber between fuel injection events or the passageways may include one or more check valves or be flattened or otherwise formed to spring shut and serve as check valves 167 to prevent oxidant entry between fuel injection events. In other instances check valves are comprised of suitably attached conical or flat disc shapes that elastically deform to distribute injected fuel in a particular oxidant utilization pattern 169 at a suitable velocity as shown in FIGS. 1N, 1P, 1R, and 1T.

FIG. 1T shows a section view of embodiment 152 in which additional heat blocking is provided by an-O-ring sealed assembly of a lower portion that may be made of matched thermal expansion material selections, with heat blocking change of phase material next to the top of 122 within ceramic 118. FIGS. 1U and 1V show additional views including fasteners and seals such as 126D, 126E, 126F, 126G, 126H, 1261 and 126J.

FIG. 1W shows another embodiment in which electrode antenna 155D or 155E may or may not also serve as a check valve that allows the flow of pressurized fluid, (e.g., fuel) is adaptively controlled and metered by operation of valve 122H, to be injected as a suitable pattern into combustion chamber 150. In some instances, electrode 155D is made of a precipitation-hardenable alloy, such as a selection listed in Table 1, by first forming a generally conical or another configuration, such as a funnel form with flat panels or arched petals or sections that are cut or split at selected locations, such as near the edges, to provide reed valves.

Certain surface patterns or portions of the bore within ceramic 145 can be plated with semi-conductive or conductive materials to provide Lorentz ion production and acceleration between various versions of electrode 155D and enable production of activated oxidant, including ions and radical states, to clean away any debris produced on or between the electrode and ceramic assembly. Lorentz ion thrusting and/or streaming into fluid flow can be utilized for acceleration of ignition and/or completion of combustion in chamber 150. Resulting injection patterns of activated ions and/or radicals can also be utilized with corona plasma to efficiently accelerate ignition and/or completion of combustion.

Preheating by cyclic compression and combustion of embodiments 155, including variations 155D, 155E, 155F, and 155G provide rapid heat transfer to fuel that is injected to accelerate initiation and/or completion of combustion events. In some embodiments preheating fuel, such as hydrogen and/or hydrogen characterized mixtures including hydrogen with carbon monoxide and/or methane, ethane, propane or carbon dioxide, provides a higher speed of sound and thus advantageous penetration rates of the stratified fuel pattern and combustion in a much wider ratio of fuel-oxidant mixtures along with accelerated completion of combustion. Such embodiments provide high surface to volume ratios for stratified fuel rays or sheets to assure high oxidant utilization efficiency in combustion events.

In certain embodiments stationary panels, such as every other panel, is thicker than the adjacent reed valve. The manufacturing process or cut that is made to separate the thicker stationary panel from the thinner reed can be cut at an angle to provide the cut surface of the thicker panel as a valve seat for the thinner reed valve. Suitable manufacturing operations include various cold or warm working, or the embodiment to provide suitable grain orientation and refinement, overlap of the reed valve on the valve seat, and strength, optionally including age hardening to provide adequate sealing, heat transfer, and endurance in service.

Illustratively, suitable cold or warm forming and cutting to produce such reed valves may be provided by laser or electrodischarge machining (EDM), such as with a fine wire EDM, and the cuts may be at any suitable angle and pattern. The reed valves are then held in the closed position by heat treatment tooling during the precipitation hardening step to provide reed valves that are normally spring closed against each other and that provide high fatigue endurance strength as they are elastically flexed to the open condition. Various features, such as ribs and splines can be included, particularly on the outside surfaces of the reed valves, and a relatively pointed radius of curvature towards the combustion chamber provides a concentrated electrical field gradient for corona discharge in the pattern of fuel injection which can include ions and/or other activated particles to induce corona discharge.

Similarly, antenna 155E is formed with ridges, one or more of which are cut or slit along a suitable section of the apex to serve as check valves that are opened by outward fluid flow and that are urged to close by spring action and/or by the closing force produced by over pressure exerted by combustion chamber fluids. Suitable cross sectional forms of the antenna ridges include shapes, such as arches, and convex or concave surfaces. Such slits can be of any suitable extent and pattern, such as spaced slits 175 in embodiment 155D, or various alternative configurations, such as 155E. In other instances, the reed valves are made of carbon, such as single crystal pyrolytic carbon or carbon-fiber reinforced composite assemblies with protective coatings, such as silicon carbide or molybdenum disilicide. Fuel flow through the reed valves is directed into combustion chamber 150 by flow through the annular space between ceramic 145 and valves 155, such as reed valves. In certain instances, the surface of ceramic 145 that faces the reed valves is converted or plated with suitable substances, such as porcelain, semiconductive or metallic coatings.

Various features 178 such as flow directors, electric field concentrators, and/or instrumentation, such as transducers 179A, 179B, 179C, 179D, etc., that monitor pressure, temperature, and patterns of injection and/or combustion can be included in embodiments, such as 155D, 155E, and 171A-C. In some applications, such instrumentation information is conveyed to a controller, such as 216 or 322, by fiber optic filaments, insulated conductor wire, or by wireless signals. In certain applications, components 179A-D supported by features 178 provide emitters and/or receivers of ignition or process monitoring radiation, such ultraviolet wavelengths to accelerate ignition and/or completion of combustion using electronic LED emitters, such as aluminum nitride, silicon carbide, diamond, beryllium selenide, zinc selenide, and/or gallium arsenide. Cooling of such components can be provided by routing of connecting filaments near or through the fluid and/or fuel flow path, such as within 175, 121, 120, 184, and 182. As with previously disclosed features, suitable dimensions and configuration for features 178 include nano to macro dimensions and interrupted or continuous, tapered or pointed, and many other geometries that optimize performance with respect to other combustion chamber inserts and dimensions, including plasma inducing components in head gasket 158 and other locations such as 159A, 159B, 159C and 159D.

FIG. 1X shows another embodiment with a check valve 163 to block flow of combustion chamber gases into electrode antenna conduit 155. Check valve 163 can be of any suitable configuration, including a ball, or a ball segment, such as a hemisphere, or tapered form, such as a cone, etc., to provide closure against fluid flow from combustion chamber 150 and to allow and/or guide flow from valve 122H into combustion chamber 150. In some embodiments, valve 163 is urged toward the closed position by permanent magnetic poles, such as may be incorporated in valve 163 and/or the valve seat in antenna 155, and/or by a suitable spring, such as a bellows or helical spring form, that push or pull valve 163 closed. In some embodiments, valve 163 is forced open by fuel flow that enters combustion chamber 150 through slits or holes 165 in the portion of antenna 155 that interfaces combustion chamber 150 to provide one or more suitable fuel penetration patterns 169.

FIG. 1Y shows an embodiment in which the check valve 163B includes a portion of a spherical surface that is thrust to the normally closed position by a suitable spring, such as a helical compression spring made of wire, or another form 173 that can include interface features, such as 177A and 177B, to center and guide the valve to the closed position. In some instances, spring form 173 is made by a suitable manufacturing process, such as photo-etching or stamping the preform from a thin sheet of an alloy selection, such as shown in Table 1, for subsequent precipitation hardening in tooling that provides the permanent spring form with a high fatigue endurance strength. In other instances, the ball surface segment is made of a permanent magnetic material that is attracted to a ferromagnetic alloy comprising the valve seat of antenna 155 and/or that is repelled toward the normally closed position by a like pole of an opposing permanent magnet in the zone below the ball segment. Such embodiments provide very compact assemblies that are readily cooled by each fuel injection event and that can efficiently participate in Lorentz and/or corona plasma production for accelerated initiation and/or completion of combustion.

One or more field concentration features, such as the shape of antenna 155, proximate to the interface to combustion chamber 150 and/or ridges or points 171A, 171B and 171C can be used to assist corona production in the pattern of injected fuel. In certain instances, the valve seat of antenna 155 and/or check valve 163 includes or is made of a permanent magnetic material, such as AlNiCo, Nd₂Fe₁₄B, SmCo₅, or Sm(Co,Fe,Cu,Zr)₇. In some embodiments, the magnetic field thus produced can assist the production of corona in the pattern of injected fuel.

In operation, fluid such as fuel delivered to a suitable annulus 123 above valve head 122H, pressurizes the inside volume of the assembly, including bellows 126B, to exert a closing force equal to the pressure times the difference in equivalent areas (EA) of the bellows and the seal area of valve 122H times the pressure plus the force exerted by the compression loaded spring 126B. Valve 122H can have a more or less equivalent area within the valve seal diameter on a suitable valve seat in electrode 128 to exert an opening force that is more or less than the closing force due to the fluid pressure times EA, or the force exerted by spring bellows 126B, or the combination of such closing forces to enable suitable opening of valve 122H by thrust exerted by driver 102 through insulative plunger 110.

Upon opening, fluid flows from one or more passageways 121 around the periphery of valve 122H into a suitably shaped hollow electrode antenna 153 to deliver fluid, such as fuel, to the combustion chamber 150 in a suitable pattern, such as 154,155, or 169 for efficient oxidant utilization as a combustant and to insulate the products of combustion to enable work production in the power stroke of engine operation. In certain instances, corona ignition and/or acceleration of completion of combustion processes is stimulated by application of a sufficiently high voltage to electrode 128 by a suitable source, such as transformer 112 through insulated lead 117, to produce a rapidly pulsed field pattern of several nanoseconds duration, such as about 5 to 50 nanoseconds or more, between antenna 155 and various features of combustion chamber 150, such as piston 153 and/or a suitable insert in piston 153. The fluid or fuel characteristics can include a sufficiently high rate of combustion that is stimulated by one or more corona ignition pulses to enable injection before, at, or after TDC to efficiently produce torque and work at the piston speed of operation, according to adaptively controlled timing of one or more injection and one or more adaptively controlled timing of ignition events.

In certain applications, electrically conductive passageway 155 delivers fuel to check valve 161, which can be of any suitable configuration, including a conical sheet form that is attached in at least one place to serve as a combination check valve and electrode or antenna for ignition, such as spark, Lorentz ion acceleration, and/or corona production.

Embodiment 180 of FIG. 1G shows another configuration, including pressurized fluid inlet fitting 106C, for various fuel and/or coolant selections. Fitting 106C forms a seal with case 108 to provide fluid flow to one or more passageways 182 above sealed setscrew 103. A suitable compressive preload force on piezoelectric stack 102 within spring well 104 is provided by setscrew 103, as shown. Ceramic plunger 110 is initially assembled to nearly zero gaps from valve cap 122C at an assembly temperature that provides for the smallest gap.

One or more passageways 184 in case 108 convey fluid from passageways 182 to passageways, such as helical grooves 120 in ceramic insulator 118, to bias the temperature of such components toward the temperature of the fuel and/or other fluids introduced through fitting 106C. The same or other fluid selections can be utilized as heat transfer fluids in the space between spring well 104 and case 108. Selected sensors, such as combustion chamber temperature, pressure and combustion pattern monitors, including photo-optical sensors, can be provided on the top, bottom, within and/or at various positions around transparent dielectric ceramic 118 to enable adaptive control of combustion chamber processes. Similar sensors may be integrated with electrode 128 to monitor such combustion chamber events along with the operation of valve 122 and can include production of optical or other wireless signals that are transmitted through or relayed by transparent ceramic 118 to other sensors that provide communication links to controller 172, 322, and/or a controller that is packaged around or with piezoelectric stack 102.

Illustratively, a port such as 107 shown in FIG. 1F, can be utilized to charge a suitable refrigerant and/or insulator into the zone around spring well 104 and plunger 110, which can be interference fitted, staked, brazed or adhesively assembled and sealed against stack 102, and/or compression spring bellows 126. This provides maintenance of valve 122, electrode tube 128, and insulator 118 at the phase change temperature of the refrigerant to suitably control thermal expansion. Heat pipe operation is provided by heat transfer to fuel that is subsequently transferred through one or more passageways 121 to annulus 186 above the seal ring of valve 122 against electrode 128 for direct injection into combustion chamber 150.

In certain instances, one or more additional or larger heat-exchanger sleeves 188 are provided, such as near the bottom, middle or top for circulation of a suitable working fluid, such as fuel, water and/or antifreeze. Such heating or cooling arrangements may be provided with or without utilization of a voltage transformer coil and may provide thermal stabilization of a transformer or electronic controller, such as 116, 172A or B, 216, or 322, that is utilized in conjunction with embodiment 180. This provides for circulation between fittings 106E and 106D through a suitable heat transfer circuit, such as around helical passageways 105 in sleeve 188, which is assembled and sealed by suitable adhesive, braze alloy or weldment to case 108. The selected controller provides for fluid in circuit 106D-105-106E be at any suitable pressure and flow rate to produce the needed heat transfer capacity, including operation as a liquid, vapor, split-phase or heat pipe system. This provides maintenance of the temperature of case 108, including the temperature of fuel passing through suitable heat transfer circuit, such as passageways 184 and 120, for purposes of controllably limiting thermal expansion and contraction of the assembled components of embodiment 180. The range of suitable temperature swings, such as from cold start to the thermal limit of engine operation, is thus provided for a wide range of material selections and component designs.

In certain instances that compressive spring bellows 126B is joined and sealed on one end to electrode 128W and on the other end to valve 122W, which may or may not have a valve cap to provide separation and containment of the fuel, including between injection events when piezoelectric stack 102 adaptively extends plunger 110 against valve 122 to provide controllably metered fluid flow into combustion chamber 150. The phase change and/or heat pipe system comprising the annular space between spring well 104 and case 108 may be suitably pressurized, including adding or reducing the fluid inventory through fitting 107 to a magnitude that is greater or less than the fuel pressure in annulus 186. Thus, bellows 126B may be pressure loaded from the inside or the outside, or it may be pressure compensated, such as by use of one or more seals, such as 131, between plunger 110 and/or valve 122C and case 108.

In other instances spring bellows 268 of FIG. 2H or 270 of FIG. 2G is laser or electron-beam brazed or welded to a suitable fluid flow design and support structure 290 and to the valve body at 292 as shown in FIG. 2J. Alternatively bellows 270 can be directly welded or brazed or bonded by other methods to the valve stem at 298 and can utilize a support structure 294 for bonding by suitable methods such as welding or brazing at circumferential seam 296. In other instances the bellows 270 is plated by DLC, graphene, or filaments that are wrapped to provide adjustments of the CTE, spring rate and/or corrosion resistance.

FIG. 2I shows a partial section view of an outward or inward opening fuel control valve head 280 that is attached to actuator stem 269 and that presents electrode 281 to the fuel flow path into combustion chamber 288. In operation as a Lorentz ion generation and thrusting mode a suitable electric field is applied between the engine block 282 through conductor 284 such as a suitably conductive wire, sheet, or plated surface to establish ion generation between electrode 281 and conductor 284. This can establish a current that is swept by fluid flow and/or Lorentz thrust force into combustion chamber 288 and can include oxidant ions and or fuel ions depending upon the timing of inward or outward opening valve 269-280 actuation. The pattern of ions thus delivered into combustion chamber is determined by factors such as the fuel pressure, ion current magnitude and the geometry of one or more pattern shaping features 283 included on electrodes 281 and/or 284 or that may be included in insulator body 285 surrounding valve 281.

A much more rapid application of ionizing voltage such as 5 to 50 nanoseconds duration provides for corona plasma generation from electrode 276 and/or conductor 284 and may be utilized with or without operation of Lorentz ion thrust production. In certain embodiments it is of considerable advantage to initially stimulate a Lorentz ion thrust pattern of oxidant and/or fuel ions that is subsequently utilized to shape the corona plasma that follows and grows in the selected Lorentz ion pattern that is thrust into combustion chamber 288. This enables adaptive adjustments of the fuel pressure, the time of occurrence and duration of one or more openings of control valve 269-280-281, the timing and magnitude of Lorentz ion current production and thrusting and the timing and duration of corona plasma generation to adjust the fuel combustion initiation, pattern and/or completion of oxidation in combustion chamber 288 to improve torque production, fuel efficiency, and/or reduction or elimination of objectionable emissions such as oxides of nitrogen. Such adaptive adjustments improve operation with a wide variety of fuel selections that may include petroleum distillates, butane, propane ethane, methane, producer gas, ammonia, urea, fuel alcohols, and hydrogen including various mixtures or solutions of such fuel types.

Ignition and/or acceleration of homogeneous, striated or stratified fuel and oxidant combustion may be by any suitable method, including one or more chemical plasma agents, hot wire or hot spots on electrode wire bars 136 A-N or counter electrode 134, spark, Lorentz thrust ions, or corona discharge. Elevated voltage may be provided by any suitable method, including by a transformer such as 112 that delivers and contains elevated voltage by conductor 117 within insulator 115 to electrode 128.

In one of numerous modes of operation in response to crankshaft angle sensor 390 and/or combustion chamber optical and/or pressure sensors 127A or 127B, oxidant in the annular space between electrodes 128 and 134 or 138 can be ionized by application of suitable electrical voltage, such as about 15 to 45KV or higher, that is delivered from transformer 112 and/or a suitable capacitor, such as may be integrated and/or insulated with ceramic 118. Such ionized oxygen can begin combustion with fuel that is injected past valve 122H to produce an expanding penetration pattern into combustion chamber 150. Ignition may be provided by one or more sparks, Lorentz thrust ions, and/or by one or more positive or negative corona discharges, such as 5 to 40 nanosecond discharges, and/or by suitable radiofrequency corona generation that occurs in the pattern established by the penetration of fuel and/or activated oxidant in combustion chamber 150.

FIG. 1J shows an exemplary embodiment 185 for stimulation of corona plasma, including inner electrode antenna 141, which has one or more straight or curvilinear features, such as helical splines 143, that concentrate the applied electropotential in the annular space between one or more straight or curvilinear features, such as helical ridges or flutes 139 of outside electrode antenna 138 or the fuel injector port 134. In certain embodiments, electrode antenna 141 extends from electrode tube 128 and can be housed within a fuel flow director 145, such as an insulative ceramic of suitable configuration. The electrode support assembly for antenna 141 provides containment and establishes an axial travel limit of valve head 122H away from the valve seat in electrode 128, and thus, protects compressive spring bellows 126B from over-excursion and degradation of performance.

In an embodiment electrode antenna 141 is hollow or can include fiber optic filaments and can serve as a wave guide for radiation such as ultraviolet radiation for ignition of fuel and oxidant in combustion chamber 150. In such applications the pattern of radiation can be provided by refraction or reflection to include the pattern of fuel injection into oxidant in combustion chamber 150. In other instances portions of ceramics 118 and/or 145 serves as a transparent medium for laser or other ignition radiation in chamber 150.

In certain combustion chamber applications, subassembly components, including valve 122, compression spring bellows 126B, and electrode tube 128 are located so the lower extent of electrode 128 is above, at, or within the fuel injector port 134 or liner 138 to provide a suitable gap or space for electrical events, such as Lorentz ion thrusting and/or corona plasma generation. In certain embodiments, electrode 128 can be a ceramic or a conductive alloy composited with a dielectric ceramic sleeve or coating that provides various functions, including shaping the electric field that can be established between electrode 141 and the piston, or a piston insert and/or 134 or 138. In certain instances, an electric field of sufficient strength and duration is established to produce Lorentz thrust ions that are accelerated between electrodes 128 and 134 or 138 toward combustion chamber 150 followed by one or more electric field pulses of about 5 to 50 nanoseconds to produce corona plasma in the injection pattern or region beyond electrode 141 in combustion chamber 150. Expansion of the plasma pattern can be produced by additional nanosecond pulses and/or by RF or microwave excitation.

In certain embodiments, a suitable number of splines 143, such as 1, 2, 3, 4, 5, 6 or 8 are straight or helical and sharp-edged to provide concentration of the field strength by interacting with 1, 2, 3, or 4 sharp-edged straight or helical features 139 that are inwardly oriented by electrode antenna 138. Portions of features 141 that are proximate to the combustion chamber may be split and twisted to cause fuel to be swirled into the combustion chamber in more or less sympathetic or counter-current flow vectors to pre-existing swirl and/or tumble motion of compressed oxidant in combustion chamber 150.

In operation upon actuation by valve driver 102, fuel injected past valve 122 flows through one or more suitably oriented flow ports 140 or 147 in electrode 128 to pass into and through the annular space between surface 149 of ceramic 118 and ceramic 145 into combustion chamber 150 in a suitable pattern that can be determined by the shape and/or topography, including features, such as straight or curvilinear flow configurations or channels 151A, 151B etc., in ceramic 145. Corona ignition is produced in the pattern of fuel expanding into combustion chamber 150 by rapid positive or negative DC application of an electropotential field between electrode antenna 141-143 and 134 or 138-139. Illustratively, the rapid application of electropotential can be about five to fifty nanoseconds at a sufficient voltage to stimulate corona plasma in combustion chamber 150. This can be followed by additional DC pulses and/or by application of RF field to expand the initial pattern of corona plasma to accelerate initiation and/or completion of combustion in chamber 150.

In some instances, one or more suitable valve operators, such as a solenoid and/or a piezoelectric type, are utilized to pilot a pneumatic or hydraulic actuation of valve 126. Various suitable arrangements for such operations include exemplary pilot valves as disclosed in U.S. Pat. Nos. 2,931,233; 3,188,047; 3,254,675; 5,494,219; 5,878,647 and 8,387,644, which are incorporated herein by reference.

Accordingly a hydraulic, pneumatic, solenoid or piezoelectric valve driver system operates at a temperature that is controlled by heat transfer to a fluid, fluid flow, and/or a fluid subjected to variable pressure, and/or a substance comprising a change of phase. Illustratively a solenoid or piezoelectric valve driver system can be operated within components made of selected materials that produce substantially the same thermal expansion which can be nearly zero or another suitable amount within the operating temperature range encountered by the components in an internal combustion engine application.

In typical applications components may be exposed to operating temperatures in the range of about −50° C. to 450° C. Materials selected for the components can have about the same coefficient of thermal expansion to prevent dimensional mismatches or thermal stresses throughout the temperatures of operation (e.g., identical, less than 1% difference, within 5%, within 10%, etc.). In some embodiments the matching CTE is about zero. These solutions can be combined with utilization of various heat transfer or cooling sub-systems to intercept heat from the combustion chamber and/or that may be generated by other components of the assembly to reduce the temperature differences that are encountered and thus overcome dimensional problems and/or thermal endurance degradation including cyclic stress and thermal fatigue. Thus the system for delivering fluid including a valve actuator, a valve, and a valve seat component can be supported by an assembly system components that are comprised of materials with nearly the same coefficient of thermal expansion including material selections in critical zones with nearly zero coefficient of thermal expansion and/or a subsystem for blocking heat passage from one or more heat sources.

The fluid injection system can include a plasma production system such as a suitable sub system 112 for producing spark, Lorentz ion acceleration into the combustion chamber, a corona generator, or a combination of a Lorentz ion thruster and a corona generator. This enables plasma to be produced in the pattern established by fluid injection. Illustratively a piezoelectric valve actuator 102 including insulative plunger 110 can directly displace valve 122 from the normally closed position in electrode 128 to inject a sufficient amount fuel with far lower volumetric energy density in one or more bursts into combustion chamber 150 to replace diesel fuel. Production of ignition plasma in the pattern of injected fuel can be developed by thermal, laser or other radiation induced ions, Lorentz ion thrusting of fuel and/or oxidant ion currents and/or corona discharge in the expanding pattern of injected fluid.

In certain instances that it is desired to provide a faster valve opening and/or operation with a higher valve closure force or lower pressure drop from the pressure at annulus 186 to the combustion chamber 150, gap G1 may be increased between plunger 110 and valve 122 at a selected assembly temperature that simulates temperature in service that minimizes the gap G1. Alternatively, gap G-1 can be reduced or increased by the materials selected for the assembled components and/or the temperature bias provided by heating or cooling fluid, such as fuel by system 160. Accordingly, control of gap G1 as a function of temperature can provide a smaller or larger gap to enable production of greater kinetic energy by a solenoid or piezoelectric valve driver or to compensate or overcome reduced thrust force and/or excursion of valve driver 102.

Controllably increasing gap G-1 provides considerable development of kinetic energy that can be delivered from plunger 110 upon impact with valve 122 to provide quicker opening and/or operation at lower or higher pressure drop across valve 122. This enables a wide variation of adaptive timing of combustion chamber events, including the crank angle(s) that one or more fuel injections occur, along with the timing of spark, Lorentz ion thrusting, and/or corona production and similarly concerning the timing of alternative utilization of chemical plasma agents.

Embodiment 250 of FIG. 2C shows a system that is suitable for certain heat engines, including gas turbines and combustion furnace applications. A piezoelectric stack is preloaded in compression by a suitable spring well, such as bellows assembly 252, which is suspended by clamp 254 that locks the collar of the bellows assembly within support case 108. FIG. 2D shows a fuel spray distributor embodiment 255 that is attached at one or more places to electrode antenna tube 155. Distributor 255 is spring closed against tube 155 to serve as a check valve against inward flow and provides elastic deformation to allow outward flow through the slits that form between the points of attachment. FIG. 2E shows another type of check valve 259 that can be formed in the shape shown by inward crimping of tube 155 into one or more folded features that allow outward flow through elastically deformed slits or wider openings that are heat treated to be spring closed to block inward flow.

FIG. 2F shows another type of flow director and/or check valve in which panels 257A, 257B, 257C, 258A, 258B and 258C spring open to allow outward flow and close against each other to restrict inward flow. Alternatively, among the numerous flow control options presented, panels 257A, 257B, and/or 257C can open from hinge features such as thinner sections that are next to stationary panels 258A, 258B and/or 258C to produce swirl motion of outward fluid flow and can spring close to restrict inward flow. In addition to the alloys listed in Table 1, another alloy that is particularly suitable for such spring closed in this and other similar operations is disclosed in U.S. Pat. No. 5,287,377, which is included herein by reference.

FIG. 2G shows a sectioned side view of embodiment 260 for direct injection of a fluid such as a coolant, oxidant, or a fuel and/or ignition of fuel in a combustion chamber, such as 150. Pressurized fluid, such as a coolant, oxidant, or fuel admitted through fitting 262, can be routed through a circuit to cool a suitable valve actuator, such as a solenoid, pneumatic, hydraulic or piezoelectric assembly 264, which includes the head of ceramic insulator 266, that is captured and sealed within spring canister 268. Actuator 264 such as a piezoelectric crystal or stack 264 is held in preloaded compression by elastic tensile force exerted by canister 268. Valve actuation is provided, illustratively by piezoelectric force transmitted through insulative plunger 266 to open valve 269 from the valve seat in stationary electrode 272. Embodiments of 272 within insulator 276 include several circuit options. This allows fluid flow past one or more suitable electrode(s), such as one or more solid forms and/or tubular embodiments such as shown in FIG. 1W, 1X, 2D, 2A, 2E or 2F into combustion chamber 150.

In other instances cooling of a specific region such as selected portions of the passageway within insulator 276 can be provided by thermoelectric or Peltier effect systems. In certain instances this can be combined with an embodiment of insulator 266 that includes suitable surface passageways such as straight or helical slots for split phase coolant that can include solid, liquid, and/or vapor phases that can be utilized to cool valve 269, bellows 270, electrode 272 and insulator 276. In other embodiments insulator 266 can incorporate an internal reservoir of coolant that receives heat from the end nearest the combustion chamber and transfers heat to case 208 which can be cooled by ambient fluids that surround the application, fluids that are transferred through fitting and/or fluids in a suitable circuit such as 105 of system 188.

In an exemplary embodiment valve 269 is opened to allow fuel flow past an annular passageway which may include vanes, ports, slots or holes to direct the flow at any desired angle ranging from 0° to 90° from the axial axis. Fuel flow that is initially directed past the outside surface of electrode antenna 272 thus displaces oxidant including activated oxidant ions and radicals such as O3, OH, NOx, that have been produced in the annular region between electrode pattern 275 and electrode antenna 272 and accelerates the resulting oxidation process system that is thrust into combustion chamber 150. The pattern of activated oxidant and fuel along with products of oxidative combustion can be enhanced and/or further activated by generation of additional fuel ions from fuel flowing past electrodes 272 and 275 and/or by ions generated by Lorentz and/or corona plasma production that extends into combustion chamber 150. In some instances high velocity, sonic, or supersonic fuel and/or fuel ions are thrust into combustion chamber 150 to accelerate the rate of collision with oxidant particles and thus the rate of ignition and/or completion of combustion.

In other instances some or all of the fluid such oxidant, coolant and/or fuel enters hollow electrode antenna 274 which provides a pattern of elastically closed slots to the annular space between electrode antenna 274 and ceramic insulator 276 for injection into combustion chamber 150. Ignition and/or acceleration of combustion of injected fuel is provided by Lorentz ions that are thrust from the coaxial electrodes, including portions of 274 and 276, and/or corona plasma development, by sufficiently rapid development of adequate electric field potential by antenna 274.

Such ignition events may utilize a voltage generator component such as transformer 278 that, in some embodiments, comprises a series of coaxial magnet wire windings carrying a surge of current to produce a high voltage that is delivered by an extension of magnet wire to electrode 272. In certain embodiments, such magnet wire is further insulated within a suitable substance, such as ceramic, glass-ceramic, boron nitride, polyimide, epoxy, or a fluorinated thermoplastic.

As illustrated in various figures including FIGS. 1N and 2G, in case of a failure in a spring, such as bellows spring 126B or the weld attachments 122W or 128W to the valve stem of 122 or to the electrode 128, fuel pressure closes valve 122H against the adjacent surface of 153. This prevents continued fuel flow and provides a fail-safe feature of operation. Similarly, in case of an over-stroke by actuator 264 and/or failure by compression spring or bellows 270, valve 269 is thrust against a suitably shaped surface 274 to prevent fluid flow into combustion chamber 150.

In operation, the embodiment of FIG. 2G provides dielectric insulator 276 as a voltage containment component around electrode antenna 272. In certain embodiments, a Lorentz ion current generation system is provided for use with or without a corona plasma production system. Illustratively, a suitable semiconductive or conductive material pattern 275 can serve as an electrode of a capacitor, including dielectric 271 and housing 208. Lorentz ion current can be stimulated by discharging this capacitor in the space between electrode antenna 272 and semiconductive or conductive pattern 275. This can be done one or more times that fluid, such as fuel, is flowing past actuated valve 269 and out of passageways, slots or vents in electrode antenna 272 to provide ions that are swept into combustion chamber 150. The fluid injection pattern can thus include ions swept from the annular space between 276, and 272 serves as a pattern for corona plasma stimulated by rapid application of an electric field in combustion chamber 150 beyond antenna 272 to accelerate initiation and/or completion of combustion of any fuel values in the combustion chamber.

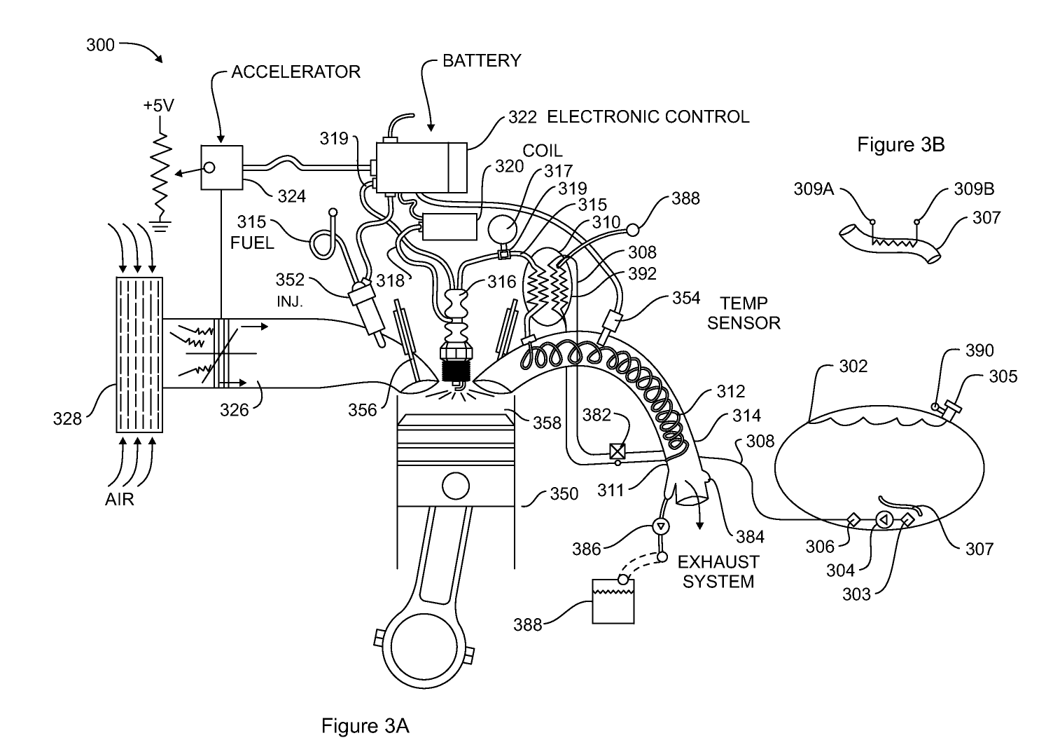

Embodiment 300 of FIGS. 3A and 3B shows a system for operation of an internal combustion engine, such as a combustion turbine or a two or four stroke piston engine 350. A fuel tank 302, such as a compressed natural gas (CNG) tank that is rated for operation at considerably elevated pressures, such as 136 to 680 (2000 to 10,000 PSI), is repurposed for:

Safely storing liquid fuel selections.

Providing conversion of renewable or waste energy into chemical and/or pressure potential energy.

Converting liquid fuel selections into vapors or gases.

Utilizing a pressurized vapor or gas to drive liquid fuel delivery to the engine.

In operation a liquid fuel, such as an alcohol (i.e. methanol, ethanol, propanol, butanol, etc.) and/or another reactant, such as formic acid, water, urea or ammonia, is inserted into tank 302 through filler valve 305 as a vapor or liquid. Initial pressurization may be provided by adding a pressurized fuel gas, such as hydrogen, methane, and/or carbon monoxide, or an inert gas, such as nitrogen, helium, or argon, through a combination fill port 390, which can also serve as a pressure relief device (PRD) in case of over pressurization, including overheating of the tank contents.

Supplemental pressurization of the contents of tank 302 can be provided by inducing a phase change of vapor condensates or liquid substances into gaseous substances by converter 307, as shown in FIGS. 3A and 3B. Assembled within tube 307 is a heating element, such as an electrical resistive or inductive heating element and/or a heated fluid circulation tube 309A-309B, which is connected to one or more suitable external circuits that are operated by electrical controller 322. Illustratively, such pressurization of tank 302 can be provided by such heat addition from sources, such as engine coolant (H-1) exhaust gases (H-3) or regenerative braking or suspension energy (H-3), to change of phase, from liquid to a vapor or gas, and/or by to respeciate a substance, such as an exemplary alcohol selection or another condensed substance, such as shown by Equations 3A, 3B, and 3C, to provide such pressurization of tank 302.

CH3OH+(H-1,H-2 and/or H-3)→CO+2H2 Equation 3A

C2H5OH+H2O+(H-1,H-2 and/or H-3)→2CO+4H2 Equation 3B

Condensed LP (e.g. C3H8)+(H-1,H-2 and/or H-3)→Pressurized Vapor C3H8 Equation 3C

Pressurized liquid fuel is delivered to through preheating conduit 308 to cool heated gases 315, such as the products that can also be produced by the exemplary process of Equations 3A, B, and/or C, by an endothermic vaporization and/or reaction in conduit 312 within countercurrent heat exchanger 311. This provides a supply of gaseous fuel, such as hydrogen or hydrogen characterized mixtures, through conduit 315 to an injector, such as 170 or 180, that is pressurized to about the supply pressure of tank 302, or this process can be provided in another tank, such as a smaller tank that is connected in series or parallel with tank 302 to supply suitably pressurized fuel. Further adjustment of the temperature of such gaseous fuel delivered to injector 316 may be provided by conditioner 160, as previously disclosed.

The rates that fluids, such as fuel, are converted to higher chemical and/or pressure potential energy are adaptively controlled according to the available endothermic heat (H-1, H-2, and/or H-3), as indicated by temperature sensors, such as 354. It is advantageous to increase the rate of conversion at times that such endothermic energy is available and to store the higher chemical and/or pressure potential energy constituents in accumulator 317 by controlled flow through valve 319.

In certain embodiments, it is advantageous to prioritize collection of condensates, such as water, by extraction of heat from the exhaust gases in counter current heat exchanger 311. At times, that cooling of such exhaust gases is provided by ambient air flow around a moving vehicle and/or upon increased utilization of H-2, condensates such as water can be collected by extraction zone 384 and delivered by gravity or pump 386 to a receiver 388, and/or for subsequent charging of tank 302 to enable thermochemically regenerative reactions. Illustratively thermochemical regeneration, such as summarized by exemplary Equation 4, includes utilization of carbon and/or hydrogen donor substances “C” that are derived from sewage, garbage, or agricultural wastes and held in solution or suspension by the liquid fuel stored in tank 302.

CH3OH+“C”+H₂O+(H-1,H-2 and/or H-3)□2CO+3H2 Equation 4

Controller 322 adaptively provides for engine 350 to be operated in an oxidant throttled mode with fuel injection through injector 352 and/or 316 to produce a homogeneous fuel-oxidant mixture ratio, according to the impedance to air flow through filter 328 is provided by variable valve 326. Alternatively, engine 350 can be adaptively operated in an unthrottled oxidant entry mode if valve 326 is fully open and can adaptively provide homogeneous or stratified combustion of fuel-oxidant mixtures that result from fuel deliveries in the circuit controlled by valve 382 for metering through injector 352 and/or 316. Adaptively timed fuel injections and ignition events are provided by controller 322, including operation of circuits that can include one or more transformers 320 and/or 112, according to operator or cruise control demand, through the position of the foot-feed or accelerator 324.

In other embodiments a Lorentz thruster, pneumatic, hydraulic, magnetostrictive or electromechanical valve driver can be utilized in zone 102. Selection of such drivers can provide larger valve opening travel to provide higher flow rates compared to typical piezoelectric driver values. Pneumatic operation with fluid substances such as air, nitrogen, or fuel gases; or hydraulic fluid substances such as engine oil, coolant, or water; or magnetic material substances such as rare earth magnets, iron, nickel cobalt, chromium, or aluminum alloys; or electromagnetic material substances such as insulated copper, aluminum, nickel, tantalum, or carbon wire are suitable for such purposes.

In other instances, water from suitable storage or sources, including condensates collected from the exhaust system, can be utilized in heat exchangers, such as 160, 188 and/or the circuit served by port 107, to control the temperature of components in assemblies 100, 170 and 180. Thus, the piezoelectric valve driver 102 can be operated within a system of components made of selected materials that produce substantially the same thermal expansion within the operating temperature range encountered by such components in an internal combustion engine application. The piezoelectric valve driver 102 can be effectively insulated by the components that produce the same thermal expansion throughout the operating range of application temperatures.

In some instances, the thermal expansion of such components can approach zero as a result of material selections that have very low or zero net thermal expansion. This typically serves internal combustion applications in which the operating temperatures of components range between about −50° C., to certain component areas that may occasionally reach 450° C. or higher, such as the temperature of the exposed surface of valve head 122H and electrode 128 in areas cyclically subjected to hot combustion chamber gases. Isolation of the components, such as case 108, ceramic 118, can be provided by insulator 132 and/or 133 to enable heat exchanges by system 160, 188 and/or the circuit served by port 107, to maintain nearly equal thermal expansion of the assembled components. In certain applications, the nearly equal net thermal expansion can be nearly zero as a result of the material selections, including metal alloys, ceramic insulator(s), clad or composited materials.

Accordingly, example embodiments of the systems and methods described herein can include:

Provide centerline guidance of valve 122 by electrode 128 to the integral valve seat in electrode 128.

Provide a compression spring and/or spring bellows 126S to seal the assembly of electrode tube 128 and valve 122 and provide low friction, infinite fatigue life as normally-closed axial valve action is enabled.

Provide a multiphase zone and/or heat pipe to suitably control the temperature of the valve driver 102, spring well 104, case 108, plunger 110, valve 122, electrode tube 128, bellows 126S and other critical components.

Establish thermal bias of components (such as matched and/or low CTE material selections) to the temperature of the fluid delivered through assemblies such as 100, 152, 170, 180, 185 and other embodiments, including various component combinations and permutations.

Be initially adjusted to provide a minimal or zero gap G1 between plunger 110 and valve 122 at a selected assembly temperature, such as the operational service temperature that minimizes the gap G1.

Alternatively, gap G-1 can be reduced or increased by the temperature bias provided by heating or cooling fluid, such as fuel by system 160 or heat exchanger 105.

Alternatively, heat exchanger 188 can use a heat exchange fluid, such as water or condensate from the exhaust of a fuel cell or engine to control the operating temperature of case 108 along with other components and the fluids contained within the assembled embodiment.

Provide a selection of methods for ignition and/or acceleration of combustion including combustion patterns that are striated, stratified, or partially homogeneous.

Utilize gasket assembly 132 to provide heat blocking to develop thermal isolation of assembly 180 and/or 185 from combustion chamber 150, along with electrode centering, and to establish the proper gap between electrodes 136 A-N and counter electrode 134 or 138.

Operate with a valve driver 102, such as an electromagnetic solenoid or piezoelectric stack, at a temperature that is controlled by heat transfer with a fluid, a flowing fluid, a fluid under variable pressure and/or more than one phase of a suitable substance.

From the foregoing, it will be appreciated that specific embodiments of the invention have been described herein for purposes of illustration, but that various modifications may be made without deviating from the spirit and scope of the various embodiments of the invention. Further, while various advantages associated with certain embodiments of the invention have been described above in the context of those embodiments, other embodiments may also exhibit such advantages, and not all embodiments need necessarily exhibit such advantages to fall within the scope of the invention. Accordingly, the invention is not limited, except as by the appended claims.

While the above description describes various embodiments of the invention and the best mode contemplated, regardless how detailed the above text, the invention can be practiced in many ways. Details of the system may vary considerably in its specific implementation, while still being encompassed by the present disclosure. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements. Further any specific numbers noted herein are only examples: alternative implementations may employ differing values or ranges.

References throughout the foregoing description to features, advantages, or similar language do not imply that all of the features and advantages that may be realized with the present technology should be or are in any single embodiment of the invention. Rather, language referring to the features and advantages is understood to mean that a specific feature, advantage, or characteristic described in connection with an embodiment is included in at least one embodiment of the present technology. Thus, discussion of the features and advantages, and similar language, throughout this specification may, but do not necessarily, refer to the same embodiment.

Furthermore, the described features, advantages, and characteristics of the present technology may be combined in any suitable manner in one or more embodiments. One skilled in the relevant art will recognize that the present technology can be practiced without one or more of the specific features or advantages of a particular embodiment. In other instances, additional features and advantages may be recognized in certain embodiments that may not be present in all embodiments of the present technology.

Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

Although certain aspects of the invention are presented below in certain claim forms, the applicant contemplates the various aspects of the invention in any number of claim forms. Accordingly, the applicant reserves the right to pursue additional claims after filing this application to pursue such additional claim forms, in either this application or in a continuing application.

I/We claim:

1. A fluid injection system comprising:
a housing with a fluid inlet port and a fluid outlet port,
a fluid metering valve,
a valve seat having a valve seat component; and
a valve actuator to axially move the metering valve from a seat in the valve seat component from a closed to an open position, the valve actuator including a piezoelectric assembly operable to displace the valve and wherein the piezoelectric assembly is configured to be exposed to fluid delivered through the fluid inlet port.

2. The system of claim 1 wherein the valve is held in the closed position against the valve seat by a compression spring bellows that seals the valve and valve seat component from fluid leakage.

3. The system of claim 2 wherein the valve actuator includes at least one of a thermal actuator and electrical actuator insulator configured to exert a sufficient force to actuate the valve from the valve seat from the closed to the open position when the piezoelectric assembly is activated.

4. The system of claim 3 wherein at the least one of a thermal and electrical insulator supports and isolates the valve seat component within the housing.

5. The system of claim 4 wherein at least two of the housing, valve, valve seat component and insulator are made of materials with a substantially similar coefficient of thermal expansion.

6. The system of claim 5 wherein the coefficient of thermal expansion is about zero at 450 degrees C.

7. The system of claim 5 wherein the materials are different materials with substantially similar coefficients of thermal expansion.

8. The system of claim 1, further comprising a plasma production subsystem configured to produce plasma in a pattern established by fluid injected into a combustion chamber from the housing.

9. The system of claim 1 wherein a temperature of one or more of the housing, valve, valve seat, valve seat component, and valve actuator is substantially similar to a temperature of a fluid injected by the fluid injection system.

10. The system of claim 1, further comprising a heat exchanger that a fluid flows through prior to entering the fluid inlet port.

11. The system of claim 1 wherein a temperature at least one of the housing, valve, valve seat, valve seat component, valve actuator and a fluid to be injected is adjusted by heat exchange by a multiphase substance or a heat pipe.

12. The system of claim 1, further comprising a fluid, wherein the fluid is a fuel that is delivered to a combustion chamber of a heat engine and a check valve is located between the combustion chamber and the metering valve to prevent the flow of combustion chamber gases toward the metering valve.

13. The system of claim 12 wherein the check valve includes at least one of an electrode and antenna.

14. The system of claim 13, further comprising a fluid, wherein the fluid is a fuel configured to be ignited by plasma developed in a pattern formed by a second fluid that is injected into a combustion chamber.

15. A system for delivering fluid comprising:
a valve;
a plunger;
a valve actuator including a piezoelectric stack configured to be activated to move the plunger against the valve to displace the valve from a closed position to an open position; and
an insulating element, wherein at least two or more of the insulating element, valve, plunger, and piezoelectric stack are made of materials having a substantially similar coefficient of thermal expansion.

16. The system of claim 15 wherein the coefficient of thermal expansion is about zero at 450 degrees C.

17. The system of claim 15 wherein the coefficient of thermal expansion of each material is between 0% and 10% of each other.

18. The system of claim 15 wherein the insulating element includes a gasket assembly for insulating the system from a combustion chamber.

19. The system of claim 15, further comprising a fluid inlet port and a fluid outlet port to deliver fluid to a combustion chamber.

20. The system of claim 19, wherein fluid delivered through the fluid inlet port is used to pre-cool or pre-heat the piezoelectric stack.
